(19) United States
(12) Patent Application Publication
(10) Pub. No.: US 2016/0350061 A1
(43) Pub. Date: Dec. 1, 2016

(54) REMOTE RENDERING FROM A SOURCE DEVICE TO A SINK DEVICE

(71) Applicant: QUALCOMM Incorporated, San Diego, CA (US)

(72) Inventors: Tyler TURNER, San Diego, CA (US); Vijay Naicker SUBRAMANIAM, San Diego, CA (US)

(21) Appl. No.: 15/165,900

(22) Filed: May 26, 2016

Related U.S. Application Data
(60) Provisional application No. 62/168,624, filed on May 29, 2015.

(51) Int. Cl. G06F 3/14; G09G 5/00; H04L 29/06; G09G 5/12

(52) U.S. Cl. CPC G06F 3/1454; G09G 5/12; G09G 5/006; H04L 65/60; G09G 2370/16; G09G 2354/00; H04B 7/24

(57) ABSTRACT

A method, an apparatus, and a computer-readable medium for wireless communication are provided. An apparatus may be configured to generate canvas rendering instructions associated with at least one application on the apparatus. The apparatus may be configured to encode the canvas rendering instructions into a data stream based on a remote rendering protocol. The apparatus may be configured to transmit the data stream to a sink device to enable at least the partial rendering of a source canvas of the apparatus onto a sink canvas of the sink device. The data stream may include the encoded canvas rendering instructions.

### CROSS-REFERENCE TO RELATED APPLICATION(S)

This application claims the benefit of U.S. Provisional Application Ser. No. 62/168,624, entitled “REMOTE RENDERING FROM A SOURCE DEVICE TO A SINK DEVICE” and filed on May 29, 2015, which is expressly incorporated by reference herein in its entirety.

### BACKGROUND

Field

The present disclosure relates generally to communication systems, and more particularly, to remote rendering from a source device to a sink device.

Background

In many telecommunication systems, communications networks are used to exchange messages among several interacting spatially-separated devices. Networks may be classified according to geographic scope, which could be, for example, a metropolitan area, a local area, or a personal area. Such networks would be designated respectively as a wide area network (WAN), metropolitan area network (MAN), local area network (LAN), wireless local area network (WLAN), wireless wide area network (WWAN), or personal area network (PAN). Networks also differ according to the switching/routing technique used to interconnect the various network nodes and devices (e.g., circuit switching vs. packet switching), the type of physical media employed for transmission (e.g., wired vs. wireless), and the set of communication protocols used (e.g., Internet protocol suite, Synchronous Optical Networking (SONET), Ethernet, etc.).

Wireless networks are often preferred when the network elements are mobile and thus have dynamic connectivity needs, or if the network architecture is formed in an ad hoc, rather than fixed, topology. Wireless networks employ intangible physical media in an unguided propagation mode using electromagnetic waves in the radio, microwave, infra-red, optical, etc., frequency bands. Wireless networks advantageously facilitate user mobility and rapid field deployment when compared to fixed wired networks.

### SUMMARY

The systems, methods, computer-readable medium, and devices of the invention each have several aspects, no single one of which is solely responsible for the invention's desirable attributes. Without limiting the scope of this invention as expressed by the claims which follow, some features will now be discussed briefly. After considering this discussion, and particularly after reading the section entitled “Detailed Description,” one will understand how the features of this invention provide advantages for devices in a wireless network.

One aspect of this disclosure provides an apparatus (e.g., a station or a user equipment (UE)) for wireless communication. The apparatus may be a source device. The source device may be configured to generate canvas rendering instructions associated with at least one application on the source device. The source device may be configured to encode the canvas rendering instructions into a data stream based on a remote rendering protocol. The source device may be configured to transmit the data stream to a sink device to enable at least the partial rendering of a source canvas onto a sink canvas. The data stream may include the encoded canvas rendering instructions.

Another aspect of this disclosure provides an apparatus (e.g., a station or a UE) for wireless communication. The apparatus may be a sink device. The sink device may be configured to receive a data stream from a source device. The data stream may include canvas rendering instructions to enable at least a partial remote rendering of a source canvas, associated with at least one application on the source device, onto a sink canvas on the sink device. The sink device may be configured to decode the data stream based on a set of data stream types. The sink device may be configured to render the sink canvas based on the decoded data stream.

### BRIEF DESCRIPTION OF THE DRAWINGS

FIG. 1 shows an example wireless communication system in which aspects of the present disclosure may be employed.

FIG. 2 is a diagram illustrating an exemplary method of performing remote rendering from a source device to a sink device.

FIG. 3 is an exemplary detailed flow diagram illustrating an overview of operations for a remote rendering service at a source device.

FIG. 4 is an exemplary detailed flow diagram illustrating the initialization details for a remote rendering service (e.g., a wireless docking service) at a source device.

FIG. 5 illustrates an exemplary call flow diagram between a source device and a sink device during remote rendering.

FIG. 6 is an exemplary detailed flow diagram illustrating the operation of caches associated with a source device and a sink device.

FIG. 7 shows an example functional block diagram of a wireless device that may perform remote rendering as a source or sink device within the wireless communication system of FIG. 1.

FIG. 8 is a flowchart of an example method for providing performing remote rendering as a source device.

FIG. 9 is a flowchart of an example method for remotely rendering encoded canvas rendering instructions on a sink device.

FIG. 10 is a functional block diagram of an example wireless communication device that may perform remote rendering either as a source device or as a sink device.

### DETAILED DESCRIPTION

Various aspects of the novel systems, apparatuses, computer program products, and methods are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. Based on the teachings herein one skilled in the art should appreciate that the scope of the disclosure is intended to cover any aspect of the novel systems, apparatuses, computer program products, and methods disclosed herein, whether implemented independently of, or combined with, any other aspect of the invention. For example, an apparatus may be implemented or a method may be practiced using any number of the aspects set forth herein. In addition, the scope of the invention is intended to cover such an apparatus or method which is practiced using other structure, functionality, or structure and functionality in addition to or other than the various aspects of the invention set forth herein. It should be understood that any aspect disclosed herein may be embodied by one or more elements of a claim.

Although particular aspects are described herein, many variations and permutations of these aspects fall within the scope of the disclosure. Although some benefits and advantages of the preferred aspects are mentioned, the scope of the disclosure is not intended to be limited to particular benefits, uses, or objectives. Rather, aspects of the disclosure are intended to be broadly applicable to different wireless technologies, system configurations, networks, and transmission protocols, some of which are illustrated by way of example in the figures and in the following description of the preferred aspects. The detailed description and drawings are merely illustrative of the disclosure rather than limiting, the scope of the disclosure being defined by the appended claims and equivalents thereof.

Popular wireless network technologies may include various types of WLANs. A WLAN may be used to interconnect nearby devices together, employing widely used networking protocols. The various aspects described herein may apply to any communication standard, such as a wireless protocol.

In some aspects, wireless signals may be transmitted according to an 802.11 protocol using orthogonal frequency-division multiplexing (OFDM), direct-sequence spread spectrum (DSSS) communications, a combination of OFDM and DSSS communications, or other schemes. Implementations of the 802.11 protocol may be used for sensors, metering, and smart grid networks. Advantageously, aspects of certain devices implementing the 802.11 protocol may consume less power than devices implementing other wireless protocols, and/or may be used to transmit wireless signals across a relatively long range, for example about one kilometer or longer.

In some implementations, a WLAN includes various devices which are the components that access the wireless network. For example, there may be two types of devices: access points (APs) and clients (also referred to as stations or “STAs”). In general, an AP may serve as a hub or base station for the WLAN and a STA serves as a user of the WLAN. For example, a STA may be a laptop computer, a personal digital assistant (PDA), a mobile phone, etc. In an example, a STA connects to an AP via a Wi-Fi (e.g., IEEE 802.11 protocol) compliant wireless link to obtain general connectivity to the Internet or to other wide area networks. In some implementations a STA may also be used as an AP.

An access point may also comprise, be implemented as, or known as a NodeB, Radio Network Controller (RNC), eNodeB, Base Station Controller (BSC), Base Transceiver Station (BTS), Base Station (BS), Transceiver Function (TF), Radio Router, Radio Transceiver, connection point, or some other terminology.

A station may also comprise, be implemented as, or known as an access terminal (AT), a subscriber station, a subscriber unit, a mobile station, a remote station, a remote terminal, a user terminal, a user agent, a user device, a user equipment, or some other terminology. In some implementations, the station may comprise a cellular telephone, a cordless telephone, a Session Initiation Protocol (SIP) phone, a wireless local loop (WLL) station, a personal digital assistant (PDA), a handheld device having wireless connection capability, or some other suitable processing device connected to a wireless modem. Accordingly, one or more aspects taught herein may be incorporated into a phone (e.g., a cellular phone or smartphone), a computer (e.g., a laptop), a portable communication device, a headset, a portable computing device (e.g., a personal data assistant), an entertainment device (e.g., a music or video device, or a satellite radio), a gaming device or system, a global positioning system device, or any other suitable device that is configured to communicate via a wireless medium.

The term “associate,” or “association,” or any variant thereof should be given the broadest meaning possible within the context of the present disclosure. By way of example, when a first apparatus associates with a second apparatus, it should be understood that the two apparatuses may be directly associated or intermediate apparatuses may be present. For purposes of brevity, the process for establishing an association between two apparatuses will be described using a handshake protocol that requires an “association request” by one of the apparatus followed by an “association response” by the other apparatus. It will be understood by those skilled in the art the handshake protocol may require other signaling, such as by way of example, signaling to provide authentication.

Any reference to an element herein using a designation such as “first,” “second,” and so forth does not generally limit the quantity or order of those elements. Rather, these designations are used herein as a convenient method of distinguishing between two or more elements or instances of an element. Thus, a reference to first and second elements does not mean that only two elements can be employed, or that the first element must precede the second element. In addition, a phrase referring to “at least one of” a list of items refers to any combination of those items, including single members. As an example, “at least one of: A, B, or C” is intended to cover: A, or B, or C, or any combination thereof (e.g., A-B, A-C, B-C, and A-B-C).

As discussed above, certain devices described herein may implement the 802.11 standard and/or the Long Term Evolution (LTE) standard, for example. Such devices, whether used as a STA or an AP or other device, may be used for smart metering or in a smart grid network. Such devices may provide sensor applications or be used in home automation. The devices may instead or in addition be used in a healthcare context, for example for personal healthcare. They may also be used for surveillance, to enable extended-range Internet connectivity (e.g. for use with hotspots), or to implement machine-to-machine communications.

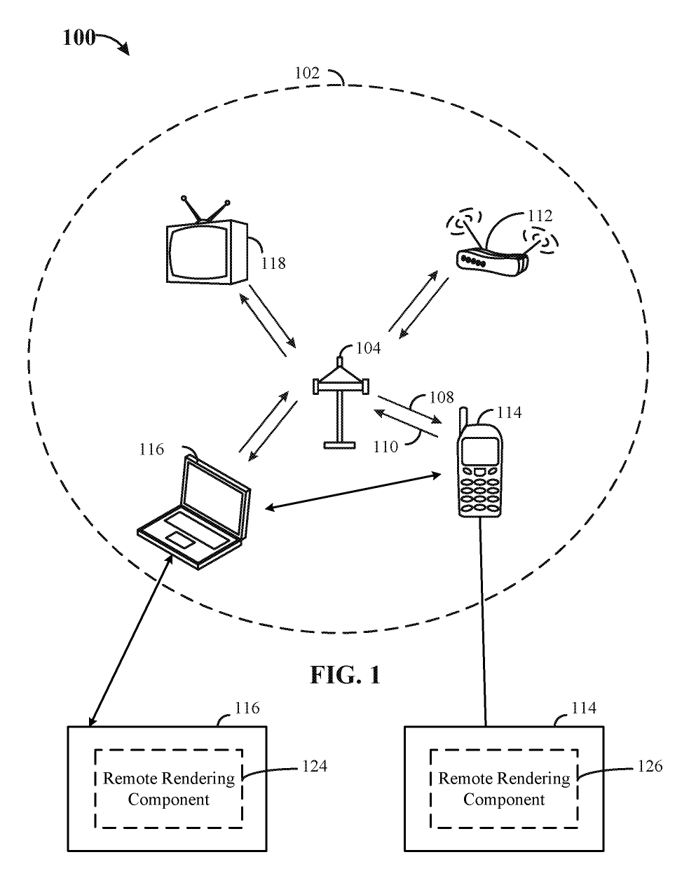

FIG. 1 shows an example wireless communication system 100 in which aspects of the present disclosure may be employed. The wireless communication system 100 may operate pursuant to one or more wireless standards, for example the 802.11 standard and/or the LTE standard. The wireless communication system 100 may include an AP 104, which communicates with STAs (e.g., STAs 112, 114, 116, and 118). In aspect, the AP 104 may be an access point in a WLAN or a base station (e.g., an evolved Node B) in an LTE network, for example.

A variety of processes and methods may be used for transmissions in the wireless communication system 100 between the AP 104 and the STAs. For example, signals may be sent and received between the AP 104 and the STAs in accordance with OFDM/OFDMA techniques. If this is the case, the wireless communication system 100 may be referred to as an OFDM/OFDMA system. Alternatively, signals may be sent and received between the AP 104 and the STAs in accordance with CDMA techniques. If this is the case, the wireless communication system 100 may be referred to as a CDMA system.

A communication link that facilitates transmission from the AP 104 to one or more of the STAs may be referred to as a downlink (DL) 108, and a communication link that facilitates transmission from one or more of the STAs to the AP 104 may be referred to as an uplink (UL) 110. Alternatively, a downlink 108 may be referred to as a forward link or a forward channel, and an uplink 110 may be referred to as a reverse link or a reverse channel. In some aspects, DL communications may include unicast or multicast traffic indications.

The AP 104 may suppress adjacent channel interference (ACI) in some aspects so that the AP 104 may receive UL communications on more than one channel simultaneously without causing significant analog-to-digital conversion (ADC) clipping noise. The AP 104 may improve suppression of ACI, for example, by having separate finite impulse response (FIR) filters for each channel or having a longer ADC backoff period with increased bit widths.

The AP 104 may act as a base station and provide wireless communication coverage in a basic service area (BSA) 102. A BSA (e.g., the BSA 102) is the coverage area of an AP (e.g., the AP 104). The AP 104 along with the STAs associated with the AP 104 and that use the AP 104 for communication may be referred to as a basic service set (BSS). It should be noted that the wireless communication system 100 may not have a central AP (e.g., AP 104), but rather may function as a peer-to-peer network between the STAs. Accordingly, the functions of the AP 104 described herein may alternatively be performed by one or more of the STAs.

The AP 104 may transmit on one or more channels (e.g., multiple narrowband channels, each channel including a frequency bandwidth) a beacon signal (or simply a “beacon”), via a communication link such as the downlink 108, to other nodes (STAs) of the wireless communication system 100, which may help the other nodes (STAs) to synchronize their timing with the AP 104, or which may provide other information or functionality. Such beacons may be transmitted periodically. In one aspect, the period between successive transmissions may be referred to as a superframe. Transmission of a beacon may be divided into a number of groups or intervals. In one aspect, the beacon may include, but is not limited to, such information as timestamp information to set a common clock, a peer-to-peer network identifier, a device identifier, capability information, a superframe duration, transmission direction information, reception direction information, a neighbor list, and/or an extended neighbor list, some of which are described in additional detail below. Thus, a beacon may include information that is both common (e.g., shared) amongst several devices and specific to a given device.

In some aspects, a STA (e.g., STA 114) may be required to associate with the AP 104 in order to send communications to and/or to receive communications from the AP 104. In one aspect, information for associating is included in a beacon broadcast by the AP 104. To receive such a beacon, the STA 114 may, for example, perform a broad coverage search over a coverage region. A search may also be performed by the STA 114 by sweeping a coverage region in a lighthouse fashion, for example. After receiving the information for associating, either from the beacon or probe response frames, the STA 114 may transmit a reference signal, such as an association probe or request, to the AP 104. In some aspects, the AP 104 may use backhaul services, for example, to communicate with a larger network, such as the Internet or a public switched telephone network (PSTN).

In an aspect, the STA 114 may include one or more components for performing various functions. For example, the STA 114 may include a remote rendering component 126 to perform procedures related to remote rendering as a source device. In one configuration, the remote rendering component 126 may be configured to generate canvas rendering instructions associated with at least one application on the source device. The remote rendering component 126 may be configured to encode the canvas rendering instructions into a data stream based on a remote rendering protocol. The remote rendering component 126 may be configured to transmit the data stream to a sink device to enable at least the partial rendering of a source canvas onto a sink canvas. The data stream may include the encoded canvas rendering instructions.

In another aspect, the STA 116 may include one or more components for performing various functions. For example, the STA 116 may include a second remote rendering component 124 to perform procedures related to remote rendering as a sink device. In one configuration, the STA 116 may remotely render the display from the STA 114. In this configuration, the second remote rendering component 124 may be configured to receive a data stream from a source device. The data stream may include canvas rendering instructions to enable at least a partial remote rendering of a source canvas, associated with at least one application on the source device, onto a sink canvas on the sink device. The second remote rendering component 124 may be configured to decode the data stream based on a set of data stream types. The second remote rendering component 124 may be configured to render the sink canvas based on the decoded data stream.

Increasingly, telephones, tablets, and other smart devices transition from being a standard mass computing platform to a primary one. Along with this trend, cloud based solutions have cropped up to link a person's data with all of their devices. However, there remain many tasks and types of data that are either predominantly used in telephones and/or difficult to move from the telephone to a laptop, desktop, or some other larger device. For example, texting is difficult to transfer between a telephone and a laptop without downloading and setting up specific applications. While some effort has been made enable transferring displays from a telephone to a laptop or to a television, for example, such methods typically require transferring an entire image buffer from the telephone to the laptop or the television. In some instances, where there is a large amount of data to be sent, a lag may be noticed. As such, a need exists to enable remote rendering between wireless devices with greater ease.

The present invention seeks to provide a convenient and useable user interface directly from a smart device to a laptop or a desktop with little initial setup. For example, common tasks that people check their telephones for such as texts and any other number of notifications (e.g., telephone calls) may be monitored and responded to directly from the computer without ever having to touch the telephone. In the present invention, instead of transmitting a full image buffer each time a frame is to be refreshed, the telephone may instead transmit raw commands and parameter data to the laptop or desktop. This enables frames that are displayed on the source device (e.g., the telephone) to be displayed on the sink device very quickly, resulting in a high frame rate. Automatic connection via Wi-Fi allows such remote rendering technology to work without the telephone or other device leaving the user's pocket. In an aspect, remote rendering technology may disable the source device's native display, allowing the source device to save power by turning off the display. Additionally, this solution saves power by sending data when a frame has changed, instead of locking the mirrored display at 30 or 60 frames per second. If the user is reading text or looking at images, no data may be used. Since remote rendering sends raw command and parameter data, as opposed to the full image buffer, bandwidth consumption is significantly reduced. In some instances, a typical frame, before images, may include 1 kilobyte (KB) of data, even for a full screen refresh. However, capturing the pixel data would be over 2 megabytes (MBs) before compression, resulting in a full-screen refresh data savings of up to 2,400 times on non-4 k displays or 8,640 times for 4 k displays.

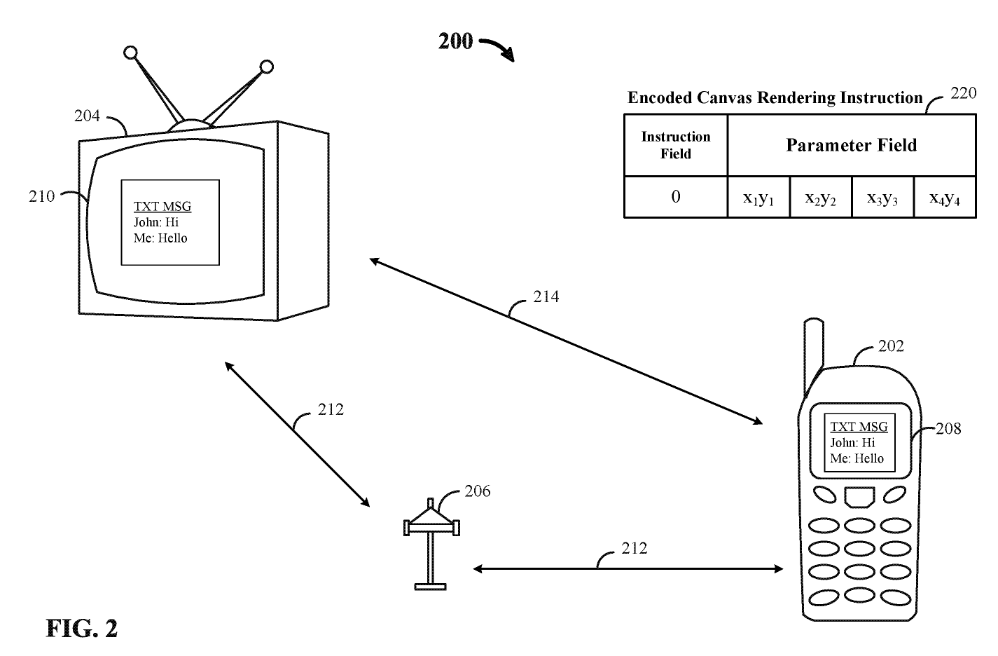

FIG. 2 is a diagram 200 illustrating an exemplary method of performing remote rendering from a source device to a sink device. Referring to FIG. 2, a source device 202 (e.g. a UE) may be communicating with a sink device 204 (e.g., a television, a laptop, or any other wireless device). In one configuration, the source device 202 may communicate with the sink device 204 over a network link 212 via an AP 206. In one aspect, the AP 206 may be an access point within a local area network (e.g., a WLAN within a building). In another aspect, the AP 206 may be a base station within a WWAN (e.g., an LTE network). In another configuration, the source device 202 may communicate with the sink device 204 over a peer-to-peer connection 214 (e.g., via Wi-Fi Direct, which may enable the source device 202 to communicate with the sink device 204 without an access point).

Referring to the source device 202, a user may be running one or more applications on the source device 202. For example, the user may be running applications such as a video streaming service, an e-mail service, a gaming service, and/or a texting service. The various applications may be overlaid on top of each other. In an aspect, the texting service may be the active application in the foreground. The user may want to remotely render the texting application onto the sink device 204 to enable the texting service onto the sink device 204.

The source device 202 may initialize a remote rendering service used to perform the remote rendering. The source device 202 may start the remote rendering service and associate the remote rendering service with one or more applications running on the source device 202. In one aspect, the remote rendering service may wait for an incoming connection (e.g., a WLAN, WWAN, or peer-to-peer connection) from the sink device 204. In another aspect, the source device 202 may initiate a connection with the sink device 204. Once a connection with the sink device 204 has been established, the source device 202 may initialize a remote rendering protocol on the source device 202. The remote rendering protocol may enable at least a partial rendering of a source canvas 208 displaying the texting application on the source device 202, for example, onto a sink canvas 210 on the sink device 204. In an aspect, a canvas may represent a display on a device. The source canvas 208 may represent a display on the source device, and the sink canvas 210 may represent a display on the sink device 204. In an aspect, the source canvas 208 may be rendered onto the sink canvas 210 even if the source device 202 is not actively displaying the source canvas 208 so long as canvas rendering instructions are still being provided by the texting application (or some other application generating data for rendering). The remote rendering protocol will enable the sink device 204 to receive the display commands and assets (e.g., images, fonts) from the source device 202 and process the display commands along with any assets from the source device 202 to render a display on the sink canvas 210.

In an aspect, when the texting application starts on the source device 202, the source device 202 may generate an application layout or display on the source canvas 208. The application layout may include the user interface of the texting service along with a message display of the communications between two or more users. To enable the application layout in every frame, the application may provide various canvas rendering instructions (e.g., display commands) to the source device 202. When the remote rendering service is active on the source device 202, the remote rendering service may use a serializing canvas (e.g., a canvas described by a sequence of serial display commands) to record the canvas rendering instructions provided by the application on the source device 202 to draw/display the application layout. As further described below, the canvas rendering instructions associated with the texting application may be provided to the sink device 204 to enable the sink device 204 to render the application display on the sink canvas 210 of the sink device 204. However, the sink device 204 and the source device 202 may not be compatible in that the canvas rendering instructions for the source device 202 may not be the same as the display commands on the sink device 204. To solve this problem, the source device 202 may provide an instruction set that translates the canvas rendering instructions from the source device 202 to a set of display commands that the sink device 204 may understand. This translation is a part of the remote rendering protocol initialization.

When the remote rendering protocol is initialized, the source device 202 may define an instruction set that includes one or more instruction types for rendering the sink canvas 210. To allow for multi-platform compatibility, the instruction set may be a program language or set of codes that is understood by many devices (e.g., java script). The instruction types in the instruction set may include instructions for drawing a rectangle, a circle, an image, and/or text (e.g., java script for drawing shapes and images). The instruction set may also include instruction types for indicating that a canvas should be cleared (e.g., delete all drawings on the canvas) or that the frame has ended and no more drawing is expected on a frame. In an aspect, the one or more instruction types translate the canvas rendering instructions from the source device 202 to a display command compatible with the sink device 204. For example, when the source device 202 transmits a canvas rendering instruction for drawing a rectangle, the instruction set may enable the sink device 204 to identify the canvas rendering instruction for drawing a rectangle, and the instruction set may provide a display command for drawing a rectangle on the sink device 204 in a program language that the sink device 204 understands (e.g., the java script code may convert the canvas rendering instructions from the source device 202 into html5 canvas commands or other display commands for the sink device 204). As such, the instruction types in the instruction set may be based on the canvas rendering instructions associated with the texting application (or any other application associated with the remote rendering service). After defining the instruction set, the source device 202 may transmit the instruction set to the sink device 204.

In another aspect, initializing of the remote rendering protocol may include defining a set of data stream types corresponding to each instruction type. Each data stream type in the set of data stream types may define a data stream format associated with an instruction type. The data stream type may enable the sink device 204 to parse and decode the data stream transmitted by the source device 202. For example, when the source device 202 wants to draw a rectangle, the remote rendering service may not only capture or record the display command for drawing the rectangle, but also, the parameter data associated with drawing a rectangle. In this example, the parameter data may be four sets of coordinates that correspond to the corners of the rectangle and that define the shape of the rectangle. If a circle is to be drawn, the application may provide a set of coordinates for the center of the circle along with radius information. As such, both the drawing command and a set of parameters associated with the drawing command may be transmitted in a data stream to the sink device 204. In order for the sink device 204 to know how to parse the data stream, the source device 202 may define a set of data stream types corresponding to each of the defined instruction types.

FIG. 2 provides an example of an encoded canvas rendering instruction 220 that the source device 202 may transmit to the sink device 204 in the data stream. In this example, the encoded canvas rendering instruction 220 represents a recorded canvas rendering instruction. The encoded canvas rendering instruction 220 may include an instruction field that includes a display command and a parameter field that includes parameter data. Using the rectangle example, an instruction field with a display command set to 0 may indicate a draw rectangle instruction for the source device 202. The encoded canvas rendering instruction 220 may also include four sets of coordinates (e.g., x₁y₁, x₂y₂, x₃y₃, and x₄y₄) in the parameter field that represent data to be used for drawing the rectangle. The sink device 204 may receive the encoded canvas rendering instruction 220 from the source device 202. The set of data stream types transmitted by the source device 202 may inform the sink device 204 a number of bits used for the instruction field, thus enabling the sink device 204 to parse the instruction field and retrieve the display command. The instruction set transmitted by the source device 202 may enable the sink device 204 to identify the display command in the instruction field and translate the display command in the instruction field to a corresponding display command on the sink device 204. The set of data types may further enable the sink device 204 to parse the remaining data in the parameter field based on the display command in the instruction field. For example, if the instruction field indicates a display command to draw a rectangle, the set of data stream types may indicate to the sink device 204 to expect four sets of coordinates in the parameter field.

In another aspect, as part of the remote rendering protocol initialization process, the source device 202 may determine a status of the connection with the sink device 204. The source device 202 may determine whether a connection has been established with the sink device 204. The source device 202 may determine the quality of the connection with the sink device 204. If a connection has been established with the sink device 204, the source device 202 may determine that the remote rendering service is ready to transmit data to the sink device 204. In an aspect, the source device 202 may determine that the remote rendering service is ready to transmit data to the sink device 204 when a connection has been established with the sink device 204 and when the quality of the connection is above a threshold (e.g., based on a received signal strength indicator).

After recording one or more canvas rendering instructions from the application with respect to the source canvas 208, the source device 202 may encode the canvas rendering instructions into a data stream. As such, a data stream may include one or more encoded canvas rendering instructions (e.g., the encoded canvas rendering instruction 220). Based on the status of the connection with the sink device 204, the source device 202 may transmit the data stream to the sink device 204 via the network link 212 and/or the peer-to-peer connection 214. In an aspect, the data stream may be transmitted in a MPEG-2 transport stream.

The sink device 204, upon receiving the data stream from the source device 202, may decode the data stream. The sink device 204 may decode the data stream based on the received set of data stream types from the source device 202 and on the received instruction set from the source device 202. The instruction set may include one or more instruction types for rendering the sink canvas 210 on the sink device 204. The instruction types may be based on the canvas rendering instructions associated with the texting application (or another application) on the source device 202. The set of data stream types may include one or more data stream formats to be received from the source device 202. Each data stream type may be associated with a corresponding instruction type. The data stream formats may enable the sink device 204 to correctly parse the data stream from the source device 202. Based on the decoded data stream, the instruction set, and the set of data stream types, the sink device 204 may render the sink canvas 210. In an aspect, the sink canvas 210 may be a partial rendering of the source canvas 208. For example, the source canvas 208 may include multiple applications overlaid on top of each other, and the texting application, which may be the active application, may be on top of all the other applications. The sink device 204 may receive canvas rendering instructions from the texting application but not the other applications. As such, the sink device 204 may render the sink canvas 210 such that the texting application appears on the sink device 204 and not the other applications running in the background of the source device 202. In another aspect, however, if all the applications are providing canvas rendering instructions to the remote rendering service on the source device 202, then the sink canvas 210 on the sink device 204 may be a full rendering of the source canvas 208.

To decode the data stream, the sink device 204 may use the received set of data stream types to parse the data stream. In an aspect, the received set of data stream types may indicate the length of the instruction field of the encoded canvas rendering instruction. The sink device 204 may parse the encoded canvas rendering instruction to determine a source display command in the instruction field, and based on the source display command associated with the source device 202, determine at least one drawing parameter associated with the source display command in the parameter field of the canvas rendering instruction. For example, by knowing that the instruction field in the canvas rendering instruction is a draw rectangle command, the sink device 204 may how to parse the remainder of the canvas rendering instruction to determine the parameters for drawing the rectangle (e.g., parse 4 sets of coordinates for each corner of the rectangle).

The sink device 204 may use the decoded data stream to render the sink canvas 210. The sink device 204 may determine a corresponding sink display command for the sink device 204 based on the instruction set and the source display command. In an aspect, the instruction set may be java script, and upon receiving the draw rectangle source display command used on the source device 202, the java script may generate a draw rectangle sink display command on the sink device 204 (e.g., in html5 code). The sink device 204 may draw a rectangle on the sink canvas 210 based on the source display command (e.g., draw rectangle in html5), which is generated based on the decoded data stream and the instruction set.

Although the aforementioned examples have discussed drawing commands with respect to a rectangle, any other shapes or objects may also be used. Also, instead of drawing shapes, an application on the source device 202 may be displaying a video stream. For example, instead of providing the pixilated, buffered frames of the video stream to the sink device 204, the source device 202 may provide the video stream that the application on the source device 202 receives to the sink device 204. In an aspect, the video stream may be provided in an MPEG-2 transport stream. In some instances, along with the video stream, the source device 202 may also transmit rendering instructions for displaying the video stream to the sink device 204.

In another aspect, the application on the source device 202 may display an image. When an application on the source device 202 first requests to draw an image, the source device 202 may generate an image identifier (ID) associated with the image and store the image and the image ID in a source cache (e.g., a memory). The remote rendering service may provide the image along with the image ID to the sink device 204. In an aspect, the image and image ID may be provided in a transmission channel separate from the transmission channel used for providing the canvas rendering instructions to enable greater throughput. The sink device 204 may store the image and the image ID upon receipt from the source device 202. In subsequent requests to draw the same image (e.g., a logo), the source device 202 may provide the image ID, instead of the entire image, to the sink device 204. Although this example uses an image as an example, any other asset (e.g., a font) may be used. As such, the source device 202 may cache any new asset with an asset ID. When the asset is first drawn on the source device 202, the remote rendering service may transmit the asset and the asset ID to the sink device 204. The sink device 204 may cache the asset and the asset ID. In subsequent requests to draw the asset, the source device 202 may transmit just the asset ID to the sink device 204.

In sum, the sink device 204 may render the sink canvas 210 by drawing shapes, images, or text and/or by displaying a video streams based on received canvas rendering instructions from the source device 202. In an aspect, audio data from the source device 202 may also be played on the sink device 204.

Having rendered the sink canvas 210, the sink device 204 may receive user input for the application (or applications) rendered on the sink device 204. For example, returning to the texting application example, the user may respond to texts received from another user. The sink device 204 may transmit the responsive texts as user input to the source device 202. The source device 202 may receive the user input from the sink device 204. The source device 202 may provide the user input to the texting application on the source device 202. The source device 202 may receive new texts from the another user. As such, the application may update the source canvas 208 with the new texts. The remote rendering service may record updated canvas rendering instructions and encode the updated canvas rendering instructions based on the remote rendering protocol. Then, the source device 202 may transmit a second data stream to the sink device 204 that includes the encoded, updated canvas rendering instructions.

The sink device 204 may receive the second data stream and decode the second data stream based on the set of data stream types and the instruction set. The sink device 204 may render the sink canvas 210 based on the decoded second data stream using the instruction set.

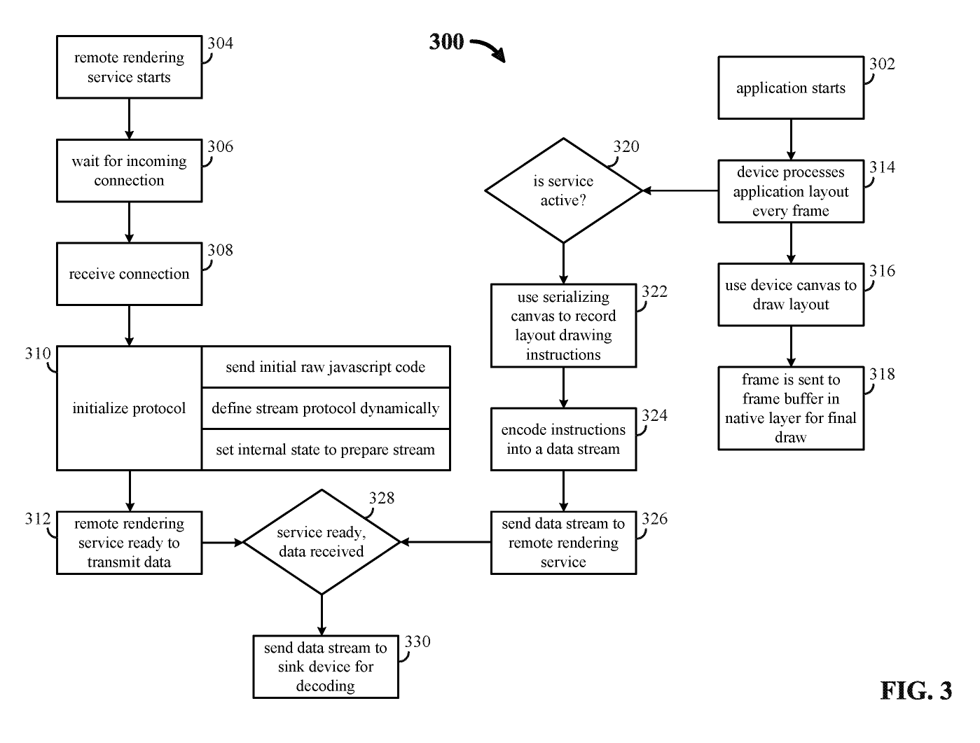

FIG. 3 is an exemplary detailed flow diagram 300 illustrating an overview of operations for a remote rendering service at a source device. At block 302, an application (e.g., a texting application, an e-mail application, a gaming application, or any other application) on the source device (e.g., the source device 202) may be initiated. At block 304, a remote rendering service (e.g., a wireless docking service) may be initiated on the source device. At block 306, the remote rendering service may wait for an incoming connection from a sink device (e.g., the sink device 204). At block 308, the remote rendering service may receive and establish a connection with the sink device. At block 310, the remote rendering service may initialize a remote rendering protocol. The remote rendering service may define an instruction set that includes one or more instruction types that enables the sink device to understand canvas rendering instructions received from the source device. In an example, the instruction set may be raw java script code that translates the canvas rendering instructions from the source device into html5 code used for drawing on a sink canvas on the sink device. The remote rendering service may dynamically define a stream protocol associated with various data streams that the source device may transmit to the sink device. The stream protocol may enable the sink device to decode and parse the data stream received from various applications on the source device. Further, the remote rendering service may maintain an internal state that indicates whether the source device is ready to transmit to and/or receive data from the sink device. When the connection is established, the remote rendering service may transmit the instruction set and the set of data stream types to the sink device. After the initialization protocol is complete, and the source device is ready to transmit data, at block 312, the remote rendering service may indicate that the remote rendering service is ready to transmit data to the sink device. Meanwhile, at block 314, after the application has started, the source device may receive canvas rendering instructions from the application to process an application layout every frame. At block 316, the source device may use the source canvas (or device canvas) to draw the application layout. At block 318, the drawn canvas may be sent to the frame buffer in the native layer for final draw. Meanwhile, at block 320, the source device may determine if the remote rendering service is active. At block 322, if the remote rendering service is active, the source device may use a serializing canvas to record layout drawing instructions (or canvas rendering instructions) provided by the application. At block 324, the source device may encode the canvas rendering instructions into a data stream (e.g., translating the canvas rendering instructions such as html5 into java script or another language). The encoded canvas rendering instruction may include an instruction field, which indicates the drawing command, and a parameter field, which indicates drawing parameters associated with the drawing command. In an aspect, if the sink device is compatible with the canvas rendering instructions utilized by the source device, then the source device need not encode its canvas rendering instructions into a different set of instructions. Instead, the source device may provide the sink device with the same canvas rendering instructions, which may be encoded in a data stream. In another aspect, if the application at the source device is displaying a video stream, the video stream—rather than the contents in the frame buffer of the source device—may be sent to the sink device in the data stream. At block 326, the source device may send the data stream with the encoded instructions to the remote rendering service. At block 328, the remote rendering service may determine that the service is ready (e.g., java script code sent, data stream protocol sent, and connection is established). At block 330, the remote rendering service may transmit the data stream to the sink device for decoding.

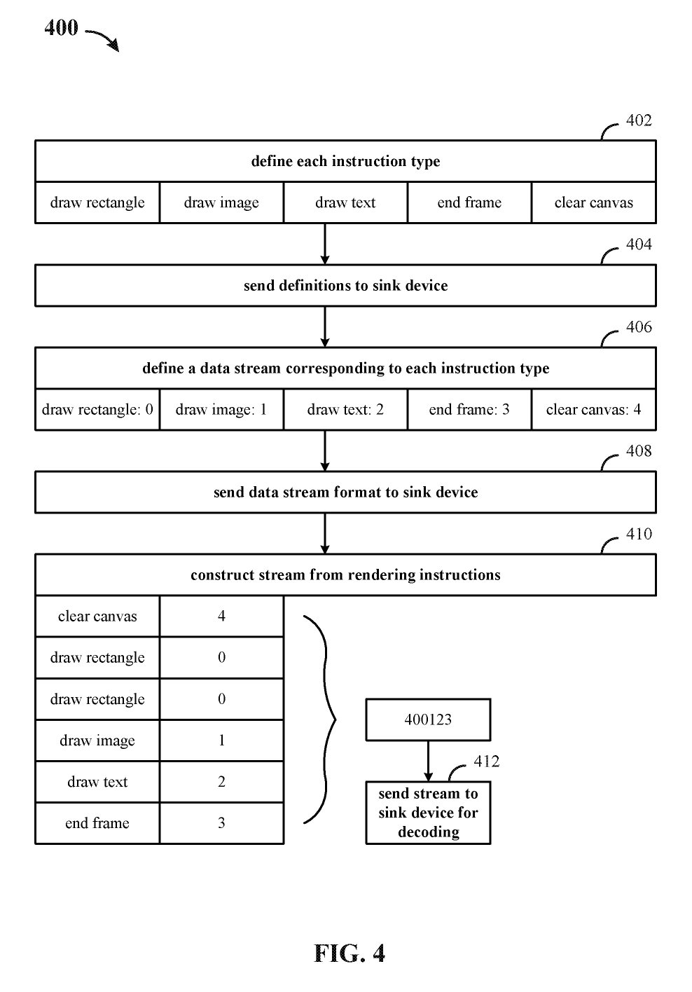

FIG. 4 is an exemplary detailed flow diagram 400 illustrating the initialization details for a remote rendering service (e.g., a wireless docking service) at a source device. At block 402, the remote rendering service may define each instruction type in an instruction set. For example, an application on the source device may have canvas rendering instructions to draw a rectangle, draw an image, draw text, indicate end of frame, and clear the canvas. Any other instruction types related to rendering a canvas may also be included. In an aspect, the remote rendering service may determine java script equivalents for each of these instructions. At block 404, the remote rendering service may transmit the instruction set (e.g., the java script code) to the sink device. At block 406, the remote rendering service may define a data stream corresponding to each instruction type. The data stream may include format information for an encoded canvas rendering instruction that includes a display command and one or more parameters associated with the display command (e.g., the encoded canvas rendering instruction 220). Referring to block 406, the display command for drawing a rectangle may be a value of 0, the display command for drawing an image may be a value of 1, the display command for drawing text may be a value of 2, the display command to indicate end of frame may be a value of 3, and the display command for clearing a canvas may be value of 4. As such, the data stream types may associate bit values (e.g., 0) with display commands (e.g., draw rectangle). For simplicity, parameters associated with each of the display commands are omitted from FIG. 4. However, such parameters may be included in the canvas rendering instructions. At block 408, after defining the set of data stream types, the remote rendering service may transmit the set of data stream types to the sink device. The sink device may use the set of data stream types to decode the encoded canvas rendering instructions. At block 410, the source device may record the various canvas rendering instructions utilized by the application. For example, the application may issue display commands to clear the canvas, draw a rectangle, draw another rectangle, draw an image, draw text, and indicate end of frame. The source device may encode the various canvas rendering instructions into a data stream. The data stream may include a serial representation of the display commands as the display commands were provided by the application (e.g., 400023). At block 412, the remote rendering service may send the data stream to the sink device for decoding and rendering.

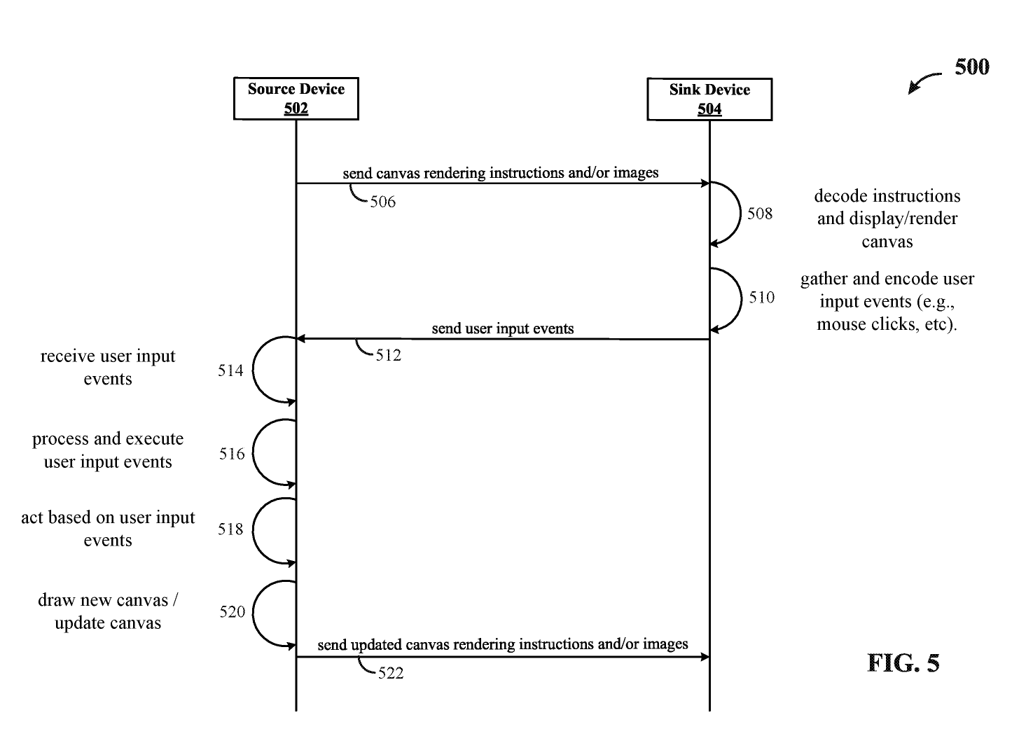

FIG. 5 illustrates an exemplary call flow diagram 500 between a source device 502 and a sink device 504 during remote rendering. In an aspect, the source device 502 may be a mobile telephone and the sink device 504 may be a laptop computer. Referring to FIG. 5, the source device 502 may start a web browsing application and a remote rendering service. The source device 502 may be communicating with the sink device 504 via a network link (e.g., the network link 212) and/or via a peer-to-peer connection (e.g., the peer-to-peer connection 214). The remote rendering service may be associated with the web browsing application in order to remotely render the source canvas onto the sink canvas. The source device 502 may send 506 encoded canvas rendering instructions, assets, and/or asset IDs to the sink device 504. In an aspect, the assets may include fonts and/or images. The web browsing application may also be displaying a video stream from a website. Accordingly, the source device 502 may also send 506 a video stream to the sink device 504. The sink device 504 may receive and decode the encoded canvas rendering instructions from the source device 502. The sink device 504 may decode 508 the canvas rendering instructions based on an instruction set and a set of data stream types previously received from the source device 502. The sink device 504 may also cache the assets and the associated asset IDs. The sink device 504 may display/render the sink canvas according to the decoded canvas rendering instructions and the video stream. In an aspect, the user may navigate to a different website on the sink device 504. The sink device 504 may gather and encode 510 the user input events (e.g., mouse clicks, keyboard entries, etc.). The sink device 504 may send 512 the user input to the source device 502. The source device 502 may receive 514 the user input events. The source device 502 may process and execute 516 the user input events. For example, the source device 502 may decode the user input events. The source device 502 may act 518 based on user input events. For example, based on user input events to navigate to a different website, the source device 502 may navigate to a different website. The source device may draw/update 520 a new canvas based on the user input events. In an aspect, when the remote rendering service is active, the updated canvas may not display on the source device 502 to conserve energy on the new device. Nevertheless, the canvas rendering instructions with respect to the new or updated canvas may still be provided by the application and recorded by the source device 502 and encoded. The source device 502 may send 522 the updated canvas rendering instructions, images, or video streams to the sink device 504. Further, although the above example indicates that a canvas is updated based on a user input event, that need not always be the case. In some aspects, the source device 502 may receive 514 user input events and process and execute 516 the user input events, but the user input events may not result in an updated canvas. Instead, the user input events, along with any associated data, may be stored or cached for later use.

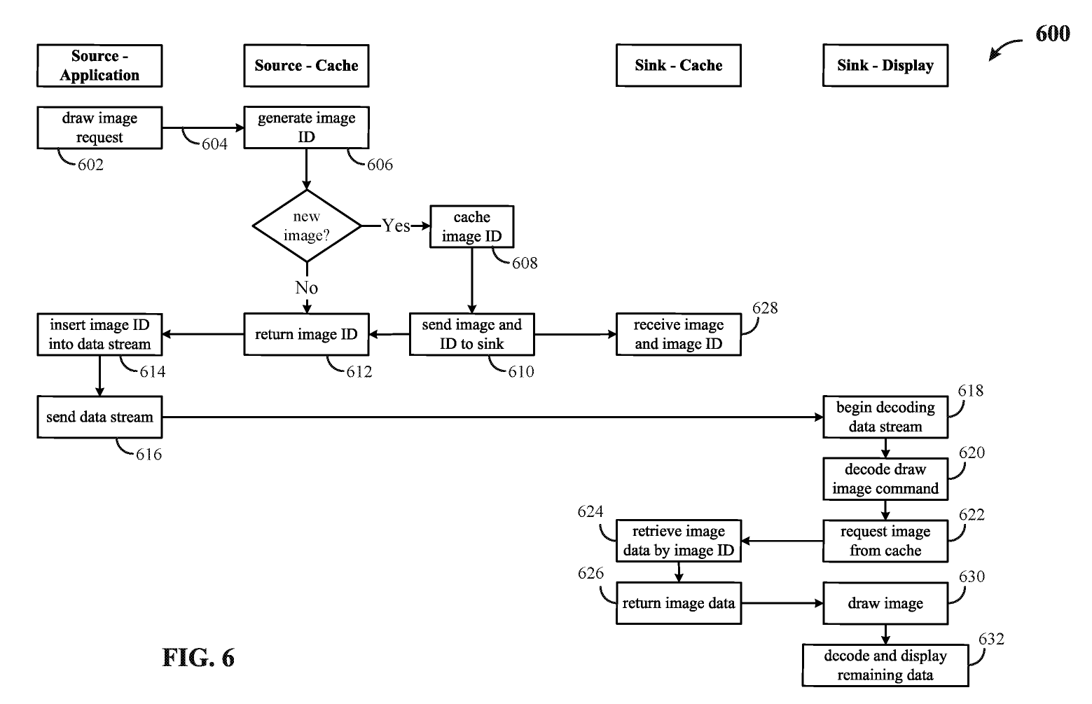

FIG. 6 is an exemplary detailed flow diagram 600 illustrating the operation of caches associated with a source device and a sink device. Referring to FIG. 6, at 602, a source application may issue a draw image request (or a draw asset request). At 604, a source application may provide an image (or an asset) with the draw image request. If the image is a new image, at 606, the source cache will generate an image ID, associate the image ID with the image, and cache both the image ID and the image (at 608). Subsequently, at 610, the source cache will send the image and image ID to the sink device to be stored in a sink cache. Then, at 612, the source cache will return the image ID to the source application. If the image is not a new image, the source cache will return the image ID to the source application at 612. Upon receiving the returned image ID, the source application may, at 614, insert the image ID into canvas rendering instructions. At 616, a remote rendering service may record the canvas rendering instructions that may include the image ID and insert the canvas rendering instructions along with the image ID into a data stream, which may be transmitted to the sink device for display on the sink display/canvas. At 618, the sink device may decode the data stream, including the draw image command (at 620). At 622, the sink device may request the image from the cache based on the received image ID. In one aspect, at 624, the sink device may retrieve the image using the image ID, and the sink cache may provide the image data to the sink device (at 626). In another aspect, the sink cache may not have the image yet. In this aspect, the sink device may wait until the sink cache has received the image from the source device (at 628). In the meantime, the sink device may execute other canvas rendering instructions until the image is received from the source device. Upon receiving the image from the source device (at 628) or from the sink cache (at 626), the sink device may draw the image (at 630). The sink device may decode and display any remaining data (at 632). By utilizing image IDs or asset IDs in the canvas rendering instructions, instead of resending images/assets each time, bandwidth may be saved and the sink device may be able to more quickly display the canvas.

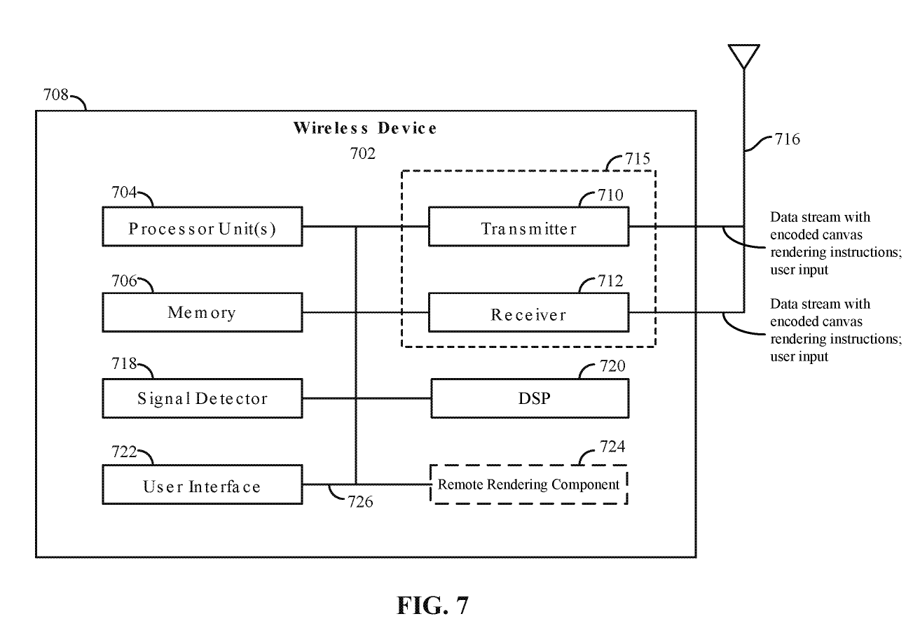

FIG. 7 shows an example functional block diagram of a wireless device 702 that may perform remote rendering as a source or sink device within the wireless communication system 100 of FIG. 1. The wireless device 702 is an example of a device that may be configured to implement the various methods described herein. For example, the wireless device 702 may comprise one of the STAs 112, 114, 116, 118, the source device 202, or the sink device 204.

The wireless device 702 may include a processor 704 which controls operation of the wireless device 702. The processor 704 may also be referred to as a central processing unit (CPU). Memory 706, which may include both read-only memory (ROM) and random access memory (RAM), may provide instructions and data to the processor 704. A portion of the memory 706 may also include non-volatile random access memory (NVRAM). The processor 704 typically performs logical and arithmetic operations based on program instructions stored within the memory 706. The instructions in the memory 706 may be executable (by the processor 704, for example) to implement the methods described herein.

The processor 704 may comprise or be a component of a processing system implemented with one or more processors. The one or more processors may be implemented with any combination of general-purpose microprocessors, microcontrollers, digital signal processors (DSPs), field programmable gate array (FPGAs), programmable logic devices (PLDs), controllers, state machines, gated logic, discrete hardware components, dedicated hardware finite state machines, or any other suitable entities that can perform calculations or other manipulations of information.

The processing system may also include machine-readable media for storing software. Software shall be construed broadly to mean any type of instructions, whether referred to as software, firmware, middleware, microcode, hardware description language, or otherwise. Instructions may include code (e.g., in source code format, binary code format, executable code format, or any other suitable format of code). The instructions, when executed by the one or more processors, cause the processing system to perform the various functions described herein.

The wireless device 702 may also include a housing 708, and the wireless device 702 may also include a transmitter 710 and/or a receiver 712 to allow transmission and reception of data between the wireless device 702 and a remote device. The transmitter 710 and the receiver 712 may be combined into a transceiver 714. An antenna 716 may be attached to the housing 708 and electrically coupled to the transceiver 714. The wireless device 702 may also include multiple transmitters, multiple receivers, multiple transceivers, and/or multiple antennas.

The wireless device 702 may also include a signal detector 718 that may be used to detect and quantify the level of signals received by the transceiver 714 or the receiver 712. The signal detector 718 may detect such signals as total energy, energy per subcarrier per symbol, power spectral density, and other signals. The wireless device 702 may also include a DSP 720 for use in processing signals. The DSP 720 may be configured to generate a packet for transmission. In some aspects, the packet may comprise a PPDU.

The wireless device 702 may further comprise a user interface 722 in some aspects. The user interface 722 may comprise a keypad, a microphone, a speaker, and/or a display. The user interface 722 may include any element or component that conveys information to a user of the wireless device 702 and/or receives input from the user.

When the wireless device 702 is implemented as a STA (e.g., the STA 114, the STA 116, the source device 202, or the sink device 204), the wireless device 702 may also comprise a remote rendering component 724. In one configuration, when the wireless device 702 is functioning as a source device (e.g., the source device 202) for purposes of remote rendering, the remote rendering component 724 may be configured to initialize a remote rendering service on the wireless device 702. The remote rendering service may be associated with at least one application on the wireless device 702. The remote rendering component 724 may be configured to establish a connection with a sink device based on the remote rendering service. The remote rendering component 724 may be configured to initialize a remote rendering protocol on the wireless device 702 to enable at least a partial rendering of a source canvas displaying the at least one application on the wireless device 702 onto a sink canvas on the sink device. The remote rendering component 724 may be configured to record canvas rendering instructions associated with the at least one application on the wireless device 702. The remote rendering component 724 may be configured to encode the canvas rendering instructions based the remote rendering protocol. The remote rendering component 724 may be configured to transmit a data stream to the sink device to enable the at least the partial rendering of the source canvas onto the sink canvas. The data stream may include the encoded canvas rendering instructions. The remote rendering component 724 may be configured to initialize the remote rendering protocol by defining an instruction set that includes one or more instruction types for rendering the sink canvas, in which each of the one or more instruction types may be based on the canvas rendering instructions associated with the at least one application on the source device, by defining a set of data stream types, in which each data stream type in the set of data stream types may be associated with each of the one or more instruction types, and by transmitting the instruction set and the set of data stream types to the sink device. In an aspect, the data stream may include a video data stream or an asset identifier associated with a cached asset on the sink device. In another configuration, the remote rendering component 724 may be configured to transmit an asset and an asset identifier to the sink device. The asset may be associated with the encoded canvas rendering instructions and the asset identifier is associated with the asset. In another configuration, the remote rendering component 724 may be configured to receive user input from the sink device based on the sink canvas and to provide the received user input to the at least one application on the wireless device 702. In another configuration, the remote rendering component 724 may be configured to record updated canvas rendering instructions, to encode the updated canvas rendering instructions based the remote rendering protocol, and to transmit a second data stream to the sink device. The second data stream may include the encoded and updated canvas rendering instructions. In another aspect, the data stream may be transmitted in an MPEG-2 transport stream.

In another configuration, when the wireless device 702 is functioning as a sink device (e.g., the sink device 204) for purposes of remote rendering, the remote rendering component 724 may be configured to receive an instruction set and a set of data stream types from a source device. The instruction set may include one or more instruction types for rendering a sink canvas on the wireless device 702, and the set of data stream types may indicate one or more data stream formats to be received from the source device. The remote rendering component 724 may be configured to receive a data stream from the source device. The data stream may include canvas rendering instructions to enable at least a partial remote rendering of a source canvas displaying at least one application on the source device onto the sink canvas on the wireless device 702. The remote rendering component 724 may be configured to decode the data stream based on the received set of data stream types from the source device. The remote rendering component 724 may be configured to render the sink canvas based on the decoded data stream and the received instruction set. In an aspect, the one or more instruction types are based on the canvas rendering instructions associated with the at least one application on the source device. Each data stream type may be associated with each of one or more instruction types. In another aspect, the data stream may include a video data stream or an asset identifier associated with a cached asset on the wireless device 702. In another configuration, the remote rendering component 724 may be configured to receive an asset and an asset identifier from the source device. In another aspect, the data stream may be received in an MPEG-2 transport stream. In another configuration, the remote rendering component 724 may be configured to decode by parsing the data stream based on the received instruction set and the received set of data stream types, by determining a source display command associated with the data stream, and by determining at least one drawing parameter associated with the source display command. In another configuration, the remote rendering component 724 may be configured to render by determining a sink display command based on the source display command and by drawing the sink canvas based on the sink display command and the at least one drawing parameter associated with the sink display command. In another configuration, the remote rendering component 724 may be configured to render by drawing the sink canvas based on a received asset or a received asset identifier. In another configuration, the remote rendering component 724 may be configured to receive user input for the at least one application based on the sink canvas and to transmit the user input to the source device. In yet another configuration, the remote rendering component 724 may be configured to receive an updated data stream from the source device, to decode the updated data stream based on the received set of data stream types from the source device and the received instruction set, and to render the sink canvas based on the decoded and updated data stream.

The various components of the wireless device 702 may be coupled together by a bus system 726. The bus system 726 may include a data bus, for example, as well as a power bus, a control signal bus, and a status signal bus in addition to the data bus. Components of the wireless device 702 may be coupled together or accept or provide inputs to each other using some other mechanism.

Although a number of separate components are illustrated in FIG. 7, one or more of the components may be combined or commonly implemented. For example, the processor 704 may be used to implement not only the functionality described above with respect to the processor 704, but also to implement the functionality described above with respect to the signal detector 718, the DSP 720, the user interface 722, and/or the remote rendering component 724. Further, each of the components illustrated in FIG. 7 may be implemented using a plurality of separate elements.

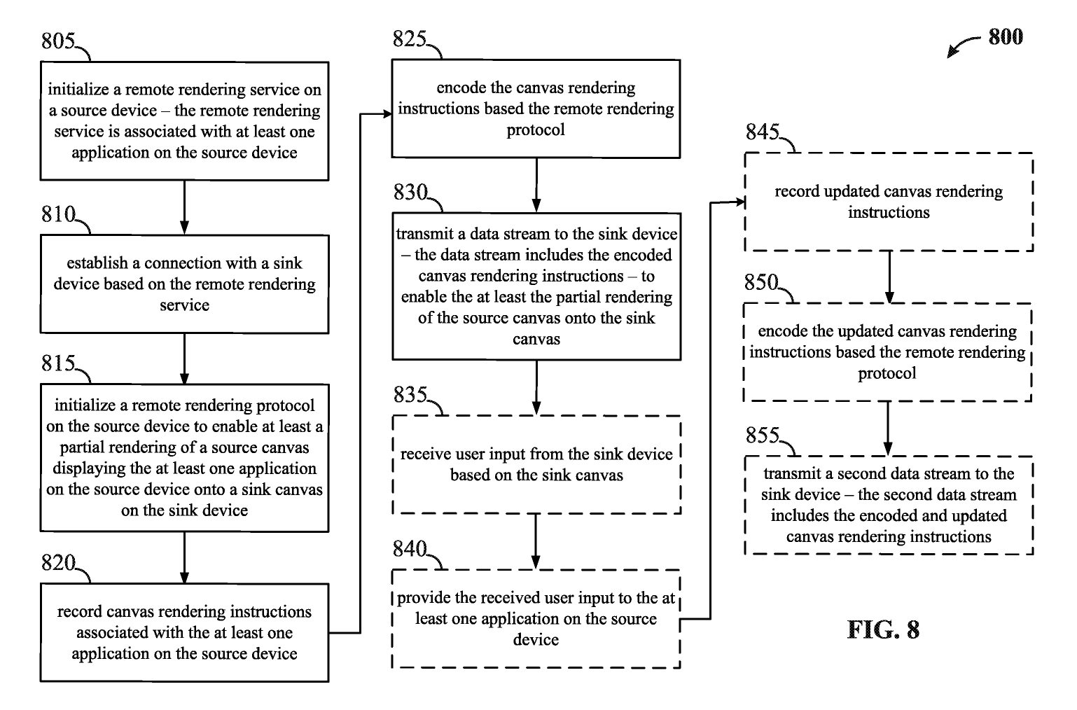

FIG. 8 is a flowchart of an example method 800 for providing performing remote rendering as a source device. The method 800 may be performed using an apparatus (e.g., the STA 114, the source device 202, or the wireless device 702, for example). Although the method 800 is described below with respect to the elements of wireless device 702 of FIG. 7, other components may be used to implement one or more of the steps described herein.

At block 805, the apparatus may initialize a remote rendering service on a source device. The remote rendering service may be associated with at least one application on the source device. For example, referring to FIG. 2, the source device 202 may initialize a remote rendering service by identifying code for the remote rendering service and by processing code to run or execute the remote rendering service. The remote rendering service may be associated with at least one application on the source device 202, such as a gaming application.

At block 810, the apparatus may establish a connection with a sink device based on the remote rendering service. For example, referring to FIG. 2, the source device 202 may establish a network link 212 with the sink device 204 based on the remote rendering service. The source device 202 may establish the network link 212 by transmitting and receiving device information (e.g., capability, network protocols, security keys) for establishing the network link 212.

At block 815, the apparatus may initialize a remote rendering protocol on the source device to enable at least a partial rendering of a source canvas displaying the at least one application on the source device onto a sink canvas on the sink device. The apparatus may initialize the remote rendering protocol by defining an instruction set that may include one or more instruction types for rendering the sink canvas, in which each of the one or more instruction types may be based on the canvas rendering instructions associated with the at least one application on the source device, by defining a set of data stream types, in which each data stream type in the set of data stream types is associated with each of the one or more instruction types, and by transmitting the instruction set and the set of data stream types to the sink device. For example, referring to FIG. 2, the source device 202 may initialize a remote rendering protocol to enable at least a partial rendering of the source canvas 208 displaying the gaming application on the source device 202 onto a sink canvas 210 on the sink device 204. The source device 202 may initialize the remote rendering protocol by defining an instruction set (e.g., in java script) that may include one or more instruction types for rendering the sink canvas 210. Each of the one more or more instruction types may be based on the canvas rendering instructions associated with the gaming application on the source device 202. That is, the instruction set may include one or more instruction types provide a translation from the source display commands, in the canvas rendering instructions, to a sink display command. The source device 202 may define a set of data stream types in which each data stream type may indicates of format of the canvas rendering instructions and enable parsing of the canvas rendering instructions for the one or more instruction types. The source device 202 may transmit the instruction set and the set of data stream types to the sink device 204.

At block 820, the apparatus may record canvas rendering instructions associated with the at least one application on the source device. For example, referring to FIG. 2, when the gaming application has started and is providing canvas rendering instructions to the source device 202 for rendering the source canvas 208, the source device 202 may record the canvas rendering instructions associated with the gaming application. To record the canvas rendering instructions, the source device 202 may identify the canvas rendering instructions provided by the gaming application and store the canvas rendering instructions in a buffer.

At block 825, the apparatus may encode the canvas rendering instructions based on the remote rendering protocol. The apparatus may encode the canvas rendering instructions into a data stream. In an aspect, the data stream may be an MPEG-2 transport stream. Referring to FIG. 2, the source device 202 may encode the canvas rendering instructions from the gaming application into a data stream based on the remote rendering protocol. The encoded canvas rendering instructions may be similar to the encoded canvas rendering instruction 220 in FIG. 2. The source device 202 may identify the source display command and insert the source display command into the instruction field. The source device 202 may insert any display command parameters into the parameter field. Each encoded canvas rendering instruction may be inserted into a data stream. The data stream may be an MPEG-2 transport stream with header information and a payload. The encoded canvas rendering instructions may form packets within the payload. Each packet in the payload may be separated by a subheader.

At block 830, the apparatus may transmit a data stream to the sink device to enable the at least the partial rendering of the source canvas onto the sink canvas. The data stream may include the encoded canvas rendering instructions. Referring to FIG. 2, the source device 202 may transmit the data stream to the sink device 204 to enable a partial rendering of the source canvas 208 onto the sink canvas 210. The data stream includes the encoded canvas rendering instructions. In another aspect, if the gaming application is displaying video on the source canvas 208, the data stream transmitted to the sink device 204 may include a video data stream. For any images (e.g., assets) that the source device 202 would like to render, the data stream may include an asset identifier associated with the image if the sink device 204 already has a copy of the image. Otherwise, if the sink device 204 does not have a copy of the image, the data stream may include the image and the image identifier. The image may be associated with the encoded canvas rendering instructions that indicate the image is to be drawn.

At block 835, the apparatus may receive user input from the sink device based on the sink canvas. For example, referring to FIG. 2, the source device 202 may receive user input from the sink device 204 based on the sink canvas 210. In the gaming application, the user may provide user input with respect to the game (e.g., moving a character within a game, or responding to prompts in the game). The sink device 204 may capture this user input and transmit the user input to the source device 202, and the source device 202 may receive the user input based on the sink canvas 210.

At block 840, the apparatus may provide the received user input to the at least one application on the apparatus. For example, referring to FIG. 2, the source device 202 may provide the user input to the gaming application.

At block 845, the apparatus may record updated canvas rendering instruction. For example, referring to FIG. 2, after providing the user input to the gaming application, the gaming application may update the source canvas 208 based on the received user input. In doing so, the gaming application may provide updated canvas rendering instructions. In response, the source device 202 may record the updated canvas rendering instructions by identifying and storing the updated canvas rendering instructions.

At block 850, the apparatus may encode the updated canvas rendering instructions based on the remote rendering protocol. For example, referring to FIG. 2, the source device 202 may encode the updated canvas rendering instructions based on the remote rendering protocol.

At block 855, the apparatus may transmit a second data stream to the sink device. The second data stream may include the encoded and updated canvas rendering instructions. For example, referring to FIG. 2, the source device 202 may transmit a second data stream to the sink device 204. The second data stream may include the encoded and updated canvas rendering instructions based on the received user input.

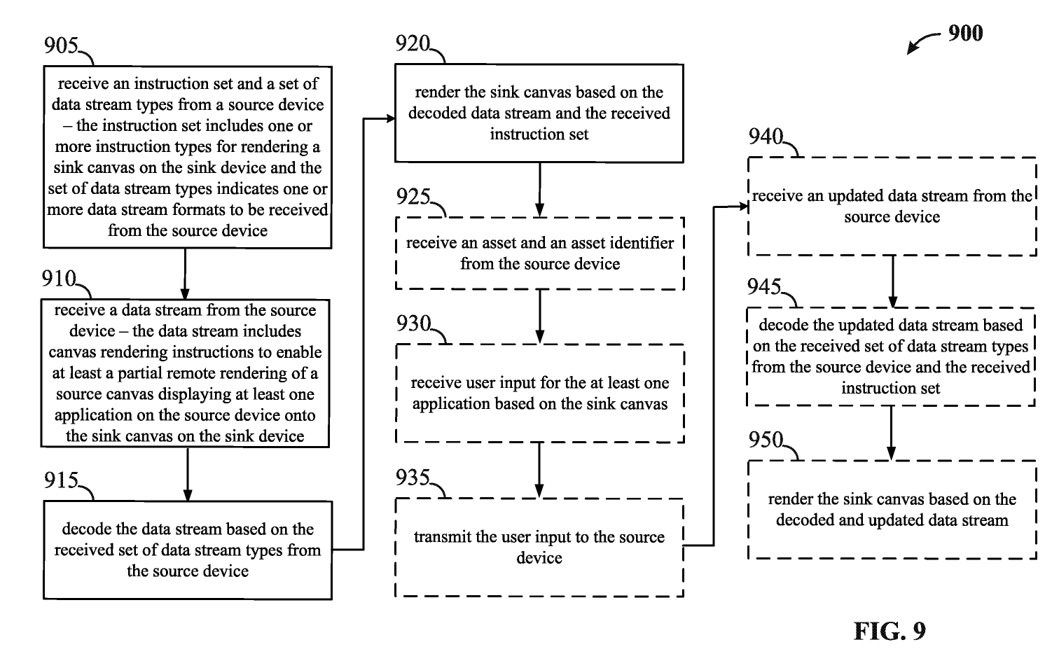

FIG. 9 is a flowchart of an example method 900 for remotely rendering encoded canvas rendering instructions on a sink device. The method 900 may be performed using an apparatus (e.g., the STA 116, the sink device 204, or the wireless device 702, for example). Although the method 900 is described below with respect to the elements of wireless device 702 of FIG. 7, other components may be used to implement one or more of the steps described herein.

At block 905, the apparatus may receive an instruction set and a set of data stream types from a source device. The instruction set may include one or more instruction types for rendering a sink canvas on the sink device, and the set of data stream types may indicate one or more data stream formats to be received from the source device. For example, referring to FIG. 2, the sink device 204 may receive an instruction set and a set of data stream types from the source device 202. The instruction set may include one or more instruction types for rendering the sink canvas 210 on the sink device 204, and the set of data stream types may indicate one or more data stream formats to be received from the source device 202.

At block 910, the apparatus may receive a data stream from the source device. The data stream may include canvas rendering instructions to enable at least a partial remote rendering of a source canvas displaying at least one application on the source device onto the sink canvas on the sink device. The one or more instruction types may be based on the canvas rendering instructions associated with the at least one application on the source device, and each data stream type is associated with each of one or more instruction types. In an aspect, the data stream may include a video stream, an asset, and/or an asset identifier. In another aspect, the data stream may be received in an MPEG-2 transport stream. For example, referring to FIG. 2, the sink device 204 may receive a data stream from the source device 202. The data stream may include canvas rendering instructions to enable a partial remote rendering of the source canvas 208 on the sink device 204.

At block 915, the apparatus may decode the data stream based on the received set of data stream types from the source device. For example, referring to FIG. 2, the sink device 204 may decode the data stream based on the received set of data stream types from the source device 202. Based on the received set of data stream types, the sink device 204 may know the format of the data stream. Accordingly, the sink device 204 may extract the source display command from the instruction field in an encoded canvas rendering instruction. Based on the extracted source display command, the sink device 204 may determine the drawing parameters associated with the source display command.

At block 920, the apparatus may render the sink canvas based on the decoded data stream and the received instruction set. In an aspect, the apparatus may render the sink canvas by determining a sink display command based on the source display command and the instruction set and by drawing the sink canvas based on the sink display command and the at least one drawing parameter associated with the sink display command. In another aspect, the apparatus may render the sink canvas by drawing the sink canvas based on a received asset or a received asset identifier. For example, referring to FIG. 2, the sink device 204 may render the sink canvas 210 based on the decoded data stream and the received instruction set. In this example, the sink device 204 may determine a sink display command based on the source display and the instruction set and by drawing the sink canvas 210 based on the sink display command and any drawing parameters associated with the sink display command as provided in the data stream in the canvas rendering instructions.

At block 925, the apparatus may receive an asset and an asset identifier from the source device. For example, referring to FIG. 2, the sink device 204 may receive a font and a font identifier from the source device 202.

At block 930, the apparatus may receive user input for the at least one application based on the sink canvas. For example, referring to FIG. 2, the sink device 204 may receive user input for the gaming application based on the sink canvas 210.

At block 935, the apparatus may transmit the user input to the source device. For example, referring to FIG. 2, the sink device 204 may transmit the user input to the source device 202.

At block 940, the apparatus may receive an updated data stream from the source device. For example, referring to FIG. 2, the sink device 204 may receive an updated data stream from the source device 202. In an aspect, the updated data stream may be based on the transmitted user input.

At block 945, the apparatus may decode the updated data stream based on the received set of data stream types from the source device and the received instruction set. For example, referring to FIG. 2, the sink device 204 may decode the updated data stream based on the received set of data stream types from the source device 202 and the received instruction set.

At block 950, the apparatus may render the sink canvas based on the decoded and updated data stream. For example, referring to FIG. 2, the sink device 204 may render the sink canvas based on the decoded and updated data stream.

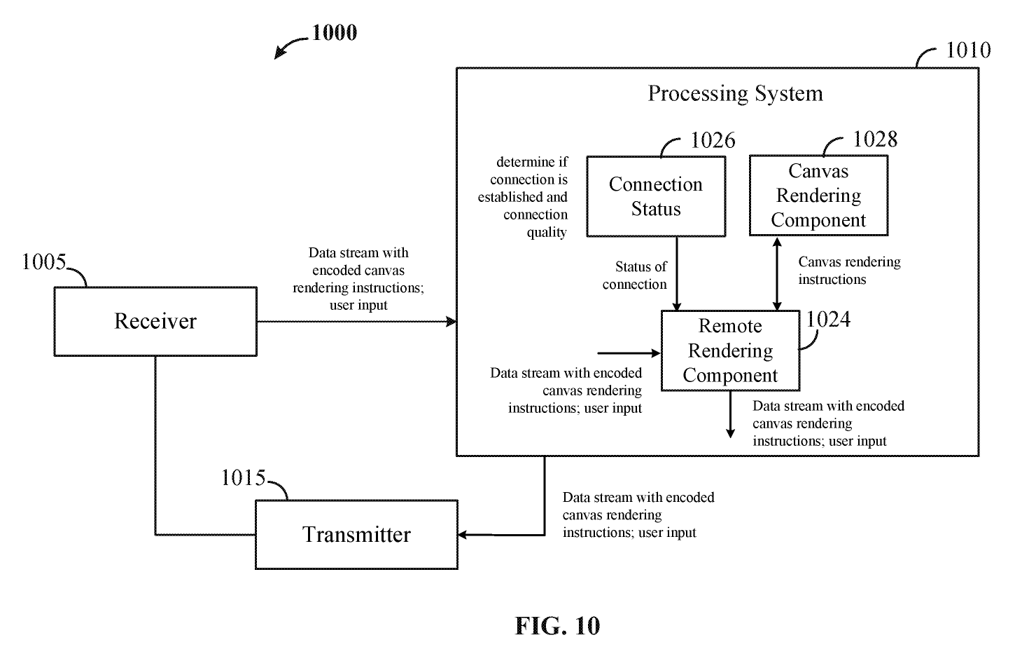

FIG. 10 is a functional block diagram of an example wireless communication device 1000 that may perform remote rendering either as a source device or as a sink device. The wireless communication device 1000 may include a receiver 1005, a processing system 1010, and a transmitter 1015. The processing system 1010 may include a remote rendering component 1024 for providing a remote rendering service as discussed herein. The processing system 1010 may further include a connection status component 1026 configured to determine if the wireless communication device 1000 has established a connection with a sink device or a source device and to determine the quality of the connection. The processing system 1010 may further include a canvas rendering component 1028 configured to provide canvas rendering instructions that may be recorded by the remote rendering component 1024 if the wireless communication device 1000 is function as a source device. In another aspect, the remote rendering component 1024 may provide canvas rendering instructions to the canvas rendering component 1028 if the wireless communication device 1000 is functioning as a sink device.

In one configuration, the wireless communication device 1000 may perform remote rendering as the source device. In this configuration, the processing system 1010 and/or the remote rendering component 1024 may generate canvas rendering instructions associated with at least one application on the wireless communication device 1000. The processing system 1010 and/or the remote rendering component 1024 may initialize a remote rendering service on the wireless communication device 1000. The remote rendering service may be associated with at least one application on the wireless communication device 1000. The processing system 1010 and/or the remote rendering component 1024 may be configured to establish a connection with a sink device based on the remote rendering service. The processing system 1010 and/or the remote rendering component 1024 may be configured to initialize a remote rendering protocol on the wireless communication device 1000 to enable at least a partial rendering of a source canvas displaying the at least one application on the wireless communication device 1000 onto a sink canvas on the sink device. The processing system 1010 and/or the remote rendering component 1024 may be configured to record canvas rendering instructions associated with the at least one application on the wireless communication device 1000. The processing system 1010 and/or the remote rendering component 1024 may be configured to encode the canvas rendering instructions based the remote rendering protocol. The processing system 1010, the remote rendering component 1024, and/or the transmitter 1015 may be configured to transmit a data stream to the sink device to enable the at least the partial rendering of the source canvas onto the sink canvas. The data stream may include the encoded canvas rendering instructions. In an aspect, the processing system 1010 and/or the remote rendering component 1024 may be configured to initialize the remote rendering protocol by defining an instruction set that includes one or more instruction types for rendering the sink canvas, in which each of the one or more instruction types may be based on the canvas rendering instructions associated with the at least one application on the source device, by defining a set of data stream types, in which each data stream type in the set of data stream types may be associated with each of the one or more instruction types, and by transmitting the instruction set and the set of data stream types to the sink device. In another aspect, the data stream may include a video data stream or an asset identifier associated with a cached asset on the sink device. In another aspect, the processing system 1010, the remote rendering component 1024, and/or the transmitter 1015 may be configured to transmit an asset and an asset identifier to the sink device. The asset may be associated with the encoded canvas rendering instructions and the asset identifier is associated with the asset. In another aspect, the processing system 1010, the remote rendering component 1024, and/or the receiver 1005 may be configured to receive user input from the sink device based on the sink canvas. The processing system 1010 and/or the remote rendering component 1024 may be configured to provide the received user input to the at least one application on the wireless communication device 1000. The processing system 1010 and/or the remote rendering component 1024 may be configured to record updated canvas rendering instructions. The processing system 1010 and/or the remote rendering component 1024 may be configured to encode the updated canvas rendering instructions based the remote rendering protocol. The processing system 1010, the remote rendering component 1024, and/or the transmitter 1015 may be configured to transmit a second data stream to the sink device. The second data stream may include the encoded and updated canvas rendering instructions. In another aspect, the data stream may be transmitted in an MPEG-2 transport stream.

In another configuration, the wireless communication device 1000 may perform remote rendering as the sink device. In this configuration, the processing system 1010, the remote rendering component 1024, and the receiver 1005 may be configured to receive an instruction set and a set of data stream types from a source device. The instruction set may include one or more instruction types for rendering a sink canvas on the wireless communication device 1000. The set of data stream types may indicates one or more data stream formats to be received from the source device. The processing system 1010, the remote rendering component 1024, and/or the receiver 1005 may be configured to receive a data stream from the source device. The data stream may include canvas rendering instructions to enable at least a partial remote rendering of a source canvas displaying at least one application on the source device onto the sink canvas on the wireless communication device 1000. The processing system 1010 and/or the remote rendering component 1024 may be configured to decode the data stream based on the received set of data stream types from the source device. The processing system 1010 and/or the remote rendering component 1024 may be configured to render the sink canvas based on the decoded data stream and the received instruction set. In an aspect, the one or more instruction types may be based on the canvas rendering instructions associated with the at least one application on the source device, and each data stream type is associated with each of one or more instruction types. In another aspect, the data stream may include a video data stream or an asset identifier associated with a cached asset on the sink device. In another aspect, the processing system 1010 and/or the remote rendering component 1024 may be configured to receive an asset and an asset identifier from the source device. In another aspect, the data stream may be received in an MPEG-2 transport stream. In another aspect, the processing system 1010 and/or the remote rendering component 1024 may be configured to decode by parsing the data stream based on the received instruction set and the received set of data stream types, by determining a source display command associated with the data stream, and by determining at least one drawing parameter associated with the source display command. In another aspect, the processing system 1010 and/or the remote rendering component 1024 may be configured to render by determining a sink display command based on the source display command and by drawing the sink canvas based on the sink display command and the at least one drawing parameter associated with the sink display command. In another aspect, the processing system 1010 and/or the remote rendering component 1024 may be configured to render by drawing the sink canvas based on a received asset or a received asset identifier. In another aspect, the processing system 1010, the remote rendering component 1024, and/or the receiver 1005 may be configured to receive user input for the at least one application based on the sink canvas. In this aspect, the processing system 1010, the remote rendering component 1024, and/or the transmitter 1015 may be configured to transmit the user input to the source device. In another aspect, the processing system 1010, the remote rendering component 1024, and/or the receiver 1005 may be configured to receive an updated data stream from the source device. In this aspect, the processing system 1010 and/or the remote rendering component 1024 may be configured to decode the updated data stream based on the received set of data stream types from the source device and the received instruction set. In this aspect, the processing system 1010 and/or the remote rendering component 1024 may be configured to render the sink canvas based on the decoded and updated data stream.

The receiver 1005, the processing system 1010, the remote rendering component 1024, and/or the transmitter 1015 may be configured to perform one or more functions discussed above with respect to blocks 805, 810, 815, 820, 825, 830, 835, 845, 850, and 855 of FIG. 8 and to blocks 905, 910, 915, 920, 925, 930, 935, 940, 945, and 950 of FIG. 9. The receiver 1005 may correspond to the receiver 712. The processing system 1010 may correspond to the processor 704. The transmitter 1015 may correspond to the transmitter 710. The remote rendering component 1024 may correspond to the remote rendering component 126, the remote rendering 124, and/or the remote rendering component 724.

In one configuration, the wireless communication device 1000 may perform remote rendering as the source device. In this configuration, the wireless communication device 1000 may include means for generating canvas rendering instructions associated with at least one application on the source device. The means for generating canvas rendering instructions may be configured to initialize a remote rendering service on the wireless communication device 1000. The remote rendering service may be associated with at least one application on the wireless communication device 1000. The means for generating may be configured to initialize a remote rendering protocol on the wireless communication device 1000 to enable at least a partial rendering of a source canvas associated with the at least one application on the wireless communication device 1000 onto a sink canvas on the sink device and to record (or store) canvas rendering instructions associated with the at least one application on the wireless communication device 1000. The wireless communication device 1000 may include means for establishing a connection with a sink device based on the remote rendering service. The wireless communication device 1000 may include means for encoding the canvas rendering instructions into a data stream based the remote rendering protocol. The wireless communication device 1000 may include means for transmitting the data stream to the sink device to enable the at least the partial rendering of the source canvas onto the sink canvas. The data stream may include the encoded canvas rendering instructions. In an aspect, the means for initializing the remote rendering protocol may be configured to define an instruction set that includes one or more instruction types for rendering the sink canvas, in which each of the one or more instruction types may be based on the canvas rendering instructions associated with the at least one application on the source device, to define a set of data stream types, in which each data stream type in the set of data stream types may be associated with each of the one or more instruction types, and to transmit the instruction set and the set of data stream types to the sink device. In another aspect, the data stream may include a video data stream or an asset identifier associated with a cached asset on the sink device. In another aspect, the wireless communication device 1000 may include means for transmitting an asset and an asset identifier to the sink device. The asset may be associated with the encoded canvas rendering instructions and the asset identifier is associated with the asset. In another aspect, the wireless communication device 1000 may include means for receiving user input from the sink device based on the sink canvas. The wireless communication device 1000 may include means for providing the received user input to the at least one application on the wireless communication device 1000. The wireless communication device 1000 may include means for recording updated canvas rendering instructions. The wireless communication device 1000 may include means for encoding the updated canvas rendering instructions based the remote rendering protocol. The wireless communication device 1000 may include means for transmitting a second data stream to the sink device. The second data stream may include the encoded and updated canvas rendering instructions. In another aspect, the data stream may be transmitted in an MPEG-2 transport stream.

For example, means for generating canvas rendering instructions may include the processing system 1010, the canvas rendering component 1028, and/or the remote rendering component 1024. Means for establishing a connection may include the processing system 1010, the connection status component 1026, the transmitter 1015, the receiver 1005, and/or the remote rendering component 1024. Means for initializing a remote rendering protocol may include the processing system 1010 and/or the remote rendering component 1024. Means for recording canvas rendering instructions may include the processing system 1010, the canvas rendering component 1028, and/or the remote rendering component 1024. Means for encoding the canvas rendering instructions may include the processing system 1010 and/or the remote rendering component 1024. Means for transmitting a data stream may include the processing system 1010, the transmitter 1015, and/or the remote rendering component 1024. Means for transmitting an asset and an asset identifier may include the processing system 1010, the transmitter 1015, and/or the remote rendering component 1024. Means for receiving user input may include the processing system 1010, the receiver 1005, and/or the remote rendering component 1024. Means for providing the received user input may include the processing system 1010 and/or the remote rendering component 1024. Means for recording the updated canvas rendering instructions may include the processing system 1010, the canvas rendering component 1028, and/or the remote rendering component 1024. Means for encoding the updated canvas rendering instructions may include the processing system 1010 and/or the remote rendering component 1024. Means for transmitting a second data stream may include the processing system 1010, the transmitter 1015, and/or the remote rendering component 1024.

In another configuration, the wireless communication device 1000 may perform remote rendering as the sink device. The wireless communication device 1000 may include means for receiving an instruction set and a set of data stream types from a source device. The instruction set may include one or more instruction types for rendering a sink canvas on the wireless communication device 1000. The set of data stream types may indicates one or more data stream formats to be received from the source device. The wireless communication device 1000 may include means for receiving a data stream from the source device. The data stream may include canvas rendering instructions to enable at least a partial remote rendering of a source canvas displaying at least one application on the source device onto the sink canvas on the wireless communication device 1000. The wireless communication device 1000 may include means for decoding the data stream based on the received set of data stream types from the source device. The wireless communication device 1000 may include means for rendering the sink canvas based on the decoded data stream and the received instruction set. In an aspect, the one or more instruction types may be based on the canvas rendering instructions associated with the at least one application on the source device, and each data stream type is associated with each of one or more instruction types. In another aspect, the data stream may include a video data stream or an asset identifier associated with a cached asset on the sink device. In another aspect, the wireless communication device 1000 may include means for receiving an asset and an asset identifier from the source device. In another aspect, the data stream may be received in an MPEG-2 transport stream. In another aspect, the means for decoding may be configured to parse the data stream based on the received instruction set and the received set of data stream types, to determine a source display command associated with the data stream, and to determine at least one drawing parameter associated with the source display command. In another aspect, the means for rendering may be configured to determine a sink display command based on the source display command and to draw the sink canvas based on the sink display command and the at least one drawing parameter associated with the sink display command. In another aspect, the means for rendering may be configured to draw the sink canvas based on a received asset or a received asset identifier. In another aspect, the wireless communication device 1000 may include means for receiving user input for the at least one application based on the sink canvas. In this aspect, the wireless communication device 1000 may include means for transmitting the user input to the source device. In another aspect, the wireless communication device 1000 may include means for receiving an updated data stream from the source device. In this aspect, the wireless communication device 1000 may include means for decoding the updated data stream based on the received set of data stream types from the source device and the received instruction set. In this aspect, the wireless communication device 1000 may include means for rendering the sink canvas based on the decoded and updated data stream.

For example, means for receiving an instruction set may include the receiver 1005, the processing system 1010, and/or the remote rendering component 1024. Means for receiving a data stream may include the receiver 1005, the processing system 1010, and/or the remote rendering component 1024. Means for decoding the data stream may include the processing system 1010 and/or the remote rendering component 1024. Means for rendering the sink canvas may include the processing system 1010, the canvas rendering component 1028, and/or the remote rendering component 1024. Means for receiving an asset and an asset identifier may include the receiver 1005, the processing system 1010, and/or the remote rendering component 1024. Means for receiving user input may include the processing system 1010 and/or the remote rendering component 1024. Means for transmitting the user input may include the transmitter 1015, the processing system 1010, and/or the remote rendering component 1024. Means for receiving an updated data stream may include the receiver 1005, the processing system 1010, and/or the remote rendering component 1024. Means for decoding the updated data stream may include the processing system 1010 and/or the remote rendering component 1024. Means for rendering the sink canvas may include the processing system 1010, the canvas rendering component 1028, and/or the remote rendering component 1024.

The various operations of methods described above may be performed by any suitable means capable of performing the operations, such as various hardware and/or software component(s), circuits, and/or module(s). Generally, any operations illustrated in the Figures may be performed by corresponding functional means capable of performing the operations.

The various illustrative logical blocks, components and circuits described in connection with the present disclosure may be implemented or performed with a general purpose processor, a DSP, an ASIC, an FPGA or other PLD, discrete gate or transistor logic, discrete hardware components or any combination thereof designed to perform the functions described herein. A general purpose processor may be a microprocessor, but in the alternative, the processor may be any commercially available processor, controller, microcontroller or state machine. A processor may also be implemented as a combination of computing devices, e.g., a combination of a DSP and a microprocessor, a plurality of microprocessors, one or more microprocessors in conjunction with a DSP core, or any other such configuration.

In one or more aspects, the functions described may be implemented in hardware, software, firmware, or any combination thereof. If implemented in software, the functions may be stored on or transmitted over as one or more instructions or code on a computer-readable medium. Computer-readable media includes both computer storage media and communication media including any medium that facilitates transfer of a computer program from one place to another. A storage media may be any available media that can be accessed by a computer. By way of example, and not limitation, such computer-readable media can comprise RAM, ROM, EEPROM, compact disc (CD) ROM (CD-ROM) or other optical disk storage, magnetic disk storage or other magnetic storage devices, or any other medium that can be used to carry or store desired program code in the form of instructions or data structures and that can be accessed by a computer. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, includes CD, laser disc, optical disc, digital versatile disc (DVD), floppy disk and Blu-ray disc where disks usually reproduce data magnetically, while discs reproduce data optically with lasers. Thus, computer-readable medium comprises a non-transitory computer readable medium (e.g., tangible media).

The methods disclosed herein comprise one or more steps or actions for achieving the described method. The method steps and/or actions may be interchanged with one another without departing from the scope of the claims. In other words, unless a specific order of steps or actions is specified, the order and/or use of specific steps and/or actions may be modified without departing from the scope of the claims.

Thus, certain aspects may comprise a computer program product for performing the operations presented herein. For example, such a computer program product may comprise a computer readable medium having instructions stored (and/or encoded) thereon, the instructions being executable by one or more processors to perform the operations described herein. For certain aspects, the computer program product may include packaging material.

Further, it should be appreciated that components and/or other appropriate means for performing the methods and techniques described herein can be downloaded and/or otherwise obtained by a user terminal and/or base station as applicable. For example, such a device can be coupled to a server to facilitate the transfer of means for performing the methods described herein. Alternatively, various methods described herein can be provided via storage means (e.g., RAM, ROM, a physical storage medium such as a CD or floppy disk, etc.), such that a user terminal and/or base station can obtain the various methods upon coupling or providing the storage means to the device. Moreover, any other suitable technique for providing the methods and techniques described herein to a device can be utilized.

It is to be understood that the claims are not limited to the precise configuration and components illustrated above. Various modifications, changes and variations may be made in the arrangement, operation and details of the methods and apparatus described above without departing from the scope of the claims.

While the foregoing is directed to aspects of the present disclosure, other and further aspects of the disclosure may be devised without departing from the basic scope thereof, and the scope thereof is determined by the claims that follow.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language claims, wherein reference to an element in the singular is not intended to mean “one and only one” unless specifically so stated, but rather “one or more.” Unless specifically stated otherwise, the term “some” refers to one or more. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. §112(f), unless the element is expressly recited using the phrase “means for” or, in the case of a method claim, the element is recited using the phrase “step for.”

What is claimed is:

1. A method of wireless communication by a source device, comprising:
generating canvas rendering instructions for a source canvas associated with at least one application on the source device;
encoding the canvas rendering instructions for the source canvas into a data stream; and
transmitting the data stream to a sink device, the data stream comprising the encoded canvas rendering instructions, to enable at least a partial rendering of the source canvas onto a sink canvas of the sink device.

2. The method of claim 1, wherein the generating the canvas rendering instructions comprises:
initializing a remote rendering protocol on the source device to enable at least the partial rendering of the source canvas, associated with the at least one application on the source device, onto the sink canvas on the sink device; and
storing canvas rendering instructions associated with the at least one application on the source device.

3. The method of claim 2, wherein the initializing the remote rendering protocol comprises:
determining an instruction set comprising one or more instruction types for rendering the sink canvas, wherein each of the one or more instruction types is based on the canvas rendering instructions associated with the at least one application on the source device;
determining a set of data stream types, wherein each data stream type in the set of data stream types is associated with each of the one or more instruction types; and
transmitting the instruction set and the set of data stream types to the sink device.

4. The method of claim 1, wherein the data stream further comprises a video data stream or an asset identifier associated with a cached asset on the sink device.

5. The method of claim 1, further comprising transmitting an asset and an asset identifier to the sink device, wherein the asset is associated with the encoded canvas rendering instructions and the asset identifier is associated with the asset.

6. The method of claim 1, further comprising:
receiving user input from the sink device based on the sink canvas; and
providing the received user input to the at least one application on the source device.

7. The method of claim 6, further comprising:
recording updated canvas rendering instructions;
encoding the updated canvas rendering instructions based a remote rendering protocol; and
transmitting a second data stream to the sink device, the second data stream comprising the encoded and updated canvas rendering instructions.

8. The method of claim 1, wherein the data stream is transmitted in an MPEG-2 transport stream.

9. An apparatus for wireless communication, the apparatus being a source device, comprising:
means for generating canvas rendering instructions for a source canvas associated with at least one application on the source device;
means for encoding the canvas rendering instructions for the source canvas into a data stream; and
means for transmitting the data stream to a sink device, the data stream comprising the encoded canvas rendering instructions, to enable at least a partial rendering of a source canvas onto a sink canvas of the sink device.

10. The apparatus of claim 9, wherein the means for generating the canvas rendering instructions is configured to:
initialize a remote rendering protocol on the source device to enable at least the partial rendering of the source canvas, associated with the at least one application on the source device, onto the sink canvas on the sink device; and
store canvas rendering instructions associated with the at least one application on the source device.

11. The apparatus of claim 10, wherein the means for generating is configured to initialize the remote rendering protocol by:
determining an instruction set comprising one or more instruction types for rendering the sink canvas, wherein each of the one or more instruction types is based on the canvas rendering instructions associated with the at least one application on the source device;
determining a set of data stream types, wherein each data stream type in the set of data stream types is associated with each of the one or more instruction types; and
transmitting the instruction set and the set of data stream types to the sink device.

12. The apparatus of claim 9, further comprising means for transmitting an asset and an asset identifier to the sink device, wherein the asset is associated with the encoded canvas rendering instructions and the asset identifier is associated with the asset.

13. The apparatus of claim 9, further comprising:
means for receiving user input from the sink device based on the sink canvas; and
means for providing the received user input to the at least one application on the source device.

14. The apparatus of claim 13, further comprising:
means for recording updated canvas rendering instructions;
means for encoding the updated canvas rendering instructions based a remote rendering protocol; and
means for transmitting a second data stream to the sink device, the second data stream comprising the encoded and updated canvas rendering instructions.

15. An apparatus for wireless communication, the apparatus being a source device, comprising:
a memory; and
at least one processor coupled to the memory and configured to:
generate canvas rendering instructions for a source canvas associated with at least one application on the source device;
encode the canvas rendering instructions into a data stream; and
transmit the data stream to a sink device, the data stream comprising the encoded canvas rendering instructions, to enable at least a partial rendering of a source canvas onto a sink canvas of the sink device.

16. The apparatus of claim 15, wherein the at least one processor is configured to generate the canvas rendering instructions by:
initializing a remote rendering protocol on the source device to enable at least the partial rendering of the source canvas, associated with the at least one application on the source device, onto the sink canvas on the sink device; and
storing canvas rendering instructions associated with the at least one application on the source device.

17. The apparatus of claim 16, wherein the at least one processor is configured to initializing the remote rendering protocol by:
determining an instruction set comprising one or more instruction types for rendering the sink canvas, wherein each of the one or more instruction types is based on the canvas rendering instructions associated with the at least one application on the source device;
determining a set of data stream types, wherein each data stream type in the set of data stream types is associated with each of the one or more instruction types; and
transmitting the instruction set and the set of data stream types to the sink device.

18. The apparatus of claim 15, wherein the data stream further comprises a video data stream or an asset identifier associated with a cached asset on the sink device.

19. The apparatus of claim 15, wherein the at least one processor is further configured to transmit an asset and an asset identifier to the sink device, wherein the asset is associated with the encoded canvas rendering instructions and the asset identifier is associated with the asset.

20. The apparatus of claim 15, wherein the at least one processor is further configured to:
receive user input from the sink device based on the sink canvas; and
provide the received user input to the at least one application on the source device.

21. The apparatus of claim 20, wherein the at least one processor is further configured to:
record updated canvas rendering instructions;
encode the updated canvas rendering instructions based a remote rendering protocol; and
transmit a second data stream to the sink device, the second data stream comprising the encoded and updated canvas rendering instructions.

22. The apparatus of claim 15, wherein the data stream is transmitted in an MPEG-2 transport stream.

23. A computer-readable medium associated with a source device and storing computer executable code, comprising code to:
generate canvas rendering instructions for a source canvas associated with at least one application on the source device;
encode the canvas rendering instructions into a data stream; and
transmit the data stream to a sink device, the data stream comprising the encoded canvas rendering instructions, to enable at least a partial rendering of a source canvas onto a sink canvas of the sink device.

24. A method of wireless communication by a sink device, comprising:
receiving a data stream from a source device, the data stream comprising canvas rendering instructions to enable at least a partial remote rendering of a source canvas, associated with at least one application on the source device, onto a sink canvas on the sink device;
decoding the data stream based on a set of data stream types; and
rendering the sink canvas based on the decoded data stream.

25. The method of claim 24, further comprising:
receiving an instruction set and a set of data stream types from a source device,
wherein the instruction set comprises one or more instruction types for rendering a sink canvas on the sink device,
wherein the set of data stream types indicates one or more data stream formats to be received from the source device,
wherein the data stream is decoded based on the received set of data stream types from the source device, and
wherein the sink canvas is rendered based on the received instruction set.

26. The method of claim 25, wherein the one or more instruction types are based on the canvas rendering instructions associated with the at least one application on the source device, and each data stream type is associated with each of one or more instruction types.

27. The method of claim 25, wherein the decoding comprises:
parsing the data stream based on the received set of data stream types;
determining a source display command associated with the parsed data stream based on the received instruction set; and
determining at least one drawing parameter associated with the source display command based on the received instruction set and the received set of data stream types.

28. The method of claim 27, wherein the rendering comprises:
determining a sink display command based on the source display command and the received instruction set;
determining at least one drawing parameter associated with the sink display command based on the at least one drawing parameter associated with the source display command; and
drawing the sink canvas based on the determined sink display command and the at least one drawing parameter associated with the sink display command.

29. The method of claim 24, wherein the data stream further comprises a video data stream or an asset identifier associated with a cached asset on the sink device.

30. The method of claim 24, further comprising receiving an asset and an asset identifier from the source device.

31. The method of claim 30, wherein the rendering further comprises drawing the sink canvas based on the received asset or the received asset identifier.

32. The method of claim 24, wherein the data stream is received in an MPEG-2 transport stream.

33. The method of claim 24, further comprising:
receiving user input for the at least one application based on the sink canvas; and
transmitting the user input to the source device.

34. The method of claim 33, further comprising:
receiving an updated data stream from the source device;
decoding the updated data stream based on a set of data stream types and an instruction set; and
rendering the sink canvas based on the decoded and updated data stream.

35. An apparatus for wireless communication, the apparatus being a sink device, comprising:
means for receiving a data stream from a source device, the data stream comprising canvas rendering instructions to enable at least a partial remote rendering of a source canvas, associated with at least one application on the source device, onto a sink canvas on the sink device;
means for decoding the data stream based on a set of data stream types; and
means for rendering the sink canvas based on the decoded data stream.

36. The apparatus of claim 35, further comprising:
means for receiving an instruction set and a set of data stream types from a source device,
wherein the instruction set comprises one or more instruction types for rendering a sink canvas on the sink device,
wherein the set of data stream types indicates one or more data stream formats to be received from the source device,
wherein the data stream is decoded based on the received set of data stream types from the source device, and
wherein the sink canvas is rendered based on the received instruction set.

37. The apparatus of claim 36, wherein the one or more instruction types are based on the canvas rendering instructions associated with the at least one application on the source device, and each data stream type is associated with each of one or more instruction types.

38. The apparatus of claim 36, wherein the means for decoding is configured to:
parse the data stream based on the received set of data stream types;
determine a source display command associated with the parsed data stream based on the received instruction set; and
determine at least one drawing parameter associated with the source display command based on the received instruction set and the received set of data stream types.

39. The apparatus of claim 38, wherein the means for rendering is configured to:
determine a sink display command based on the source display command and the received instruction set;
determine at least one drawing parameter associated with the sink display command based on the at least one drawing parameter associated with the source display command; and
draw the sink canvas based on the determined sink display command and the at least one drawing parameter associated with the sink display command.

40. The apparatus of claim 35, further comprising means for receiving an asset and an asset identifier from the source device.

41. The apparatus of claim 35, further comprising:
means for receiving user input for the at least one application based on the sink canvas; and
means for transmitting the user input to the source device.

42. The apparatus of claim 41, further comprising:
means for receiving an updated data stream from the source device;
means for decoding the updated data stream based on a set of data stream types and an instruction set; and
means for rendering the sink canvas based on the decoded and updated data stream.

43. An apparatus for wireless communication, the apparatus being a sink device, comprising:
a memory; and
at least one processor coupled to the memory and configured to:
receive a data stream from a source device, the data stream comprising canvas rendering instructions to enable at least a partial remote rendering of a source canvas, associated with at least one application on the source device, onto a sink canvas on the sink device;
decode the data stream based on a set of data stream types; and
render the sink canvas based on the decoded data stream.

44. The apparatus of claim 43, wherein the at least one processor is further configured to:
receive an instruction set and a set of data stream types from a source device,
wherein the instruction set comprises one or more instruction types for rendering a sink canvas on the sink device,
wherein the set of data stream types indicates one or more data stream formats to be received from the source device,
wherein the data stream is decoded based on the received set of data stream types from the source device, and
wherein the sink canvas is rendered based on the received instruction set.

45. The apparatus of claim 44, wherein the one or more instruction types are based on the canvas rendering instructions associated with the at least one application on the source device, and each data stream type is associated with each of one or more instruction types.

46. The apparatus of claim 44, wherein the at least one processor is configured to decode by:
parsing the data stream based on the received set of data stream types;
determining a source display command associated with the parsed data stream based on the received instruction set; and
determining at least one drawing parameter associated with the source display command based on the received instruction set and the received set of data stream types.

47. The apparatus of claim 46, wherein the at least one processor is configured to render by:
determining a sink display command based on the source display command and the received instruction set;
determining at least one drawing parameter associated with the sink display command based on the at least one drawing parameter associated with the source display command; and
drawing the sink canvas based on the determined sink display command and the at least one drawing parameter associated with the sink display command.

48. The apparatus of claim 43, wherein the data stream further comprises a video data stream or an asset identifier associated with a cached asset on the sink device.

49. The apparatus of claim 43, wherein the at least one processor is further configured to receive an asset and an asset identifier from the source device.

50. The apparatus of claim 49, wherein the at least one processor is configured to render by drawing the sink canvas based on the received asset or the received asset identifier.

51. The apparatus of claim 43, wherein the data stream is received in an MPEG-2 transport stream.

52. The apparatus of claim 43, wherein the at least one processor is further configured to:
receive user input for the at least one application based on the sink canvas; and
transmit the user input to the source device.

53. The apparatus of claim 52, wherein the at least one processor is further configured to:
receive an updated data stream from the source device;
decode the updated data stream based on a set of data stream types and an instruction set; and
render the sink canvas based on the decoded and updated data stream.

54. A computer-readable medium associated with a sink device and storing computer executable code, comprising code to:
receive a data stream from a source device, the data stream comprising canvas rendering instructions to enable at least a partial remote rendering of a source canvas, associated with at least one application on the source device, onto a sink canvas on the sink device;
decode the data stream based on a set of data stream types; and
render the sink canvas based on the decoded data stream.
